(19) United States
(12) Patent Application Publication
(10) Pub. No.: US 2004/0093275 A1
(43) Pub. Date: May 13, 2004

(54) Internet-based marketing and sales application and method for targeted marketing of a product and/or service

(76) Inventors: Robert Snelson, Mississauga (CA); Jason Bednarz, Toronto (CA); Dean Morrissey, Burlington (CA); Sebastian Higgins, Toronto (CA); Toks Odesanya, Toronto (CA)

Correspondence Address: MERCHANT & GOULD PC, P.O. BOX 2903, MINNEAPOLIS, MN, 55402-0903, US

(21) Appl. No.: 10/291,867

(22) Filed: Nov. 7, 2002

(51) Int. Cl. G06F 17/60

(52) U.S. Cl. 705/26

(57) ABSTRACT

A distributed computer network includes an item provider computer system maintaining at least one campaign in a database. The at least one campaign identifies a list of prospects operating businesses in a common industry that are within a specified geographical area. The item provider computer system runs a marketing and sales application that allows an item provider to electronically appoint a telemarketer for the at least one campaign and an agent for the at least one campaign. At least one telemarketer client computer system communicates with the item provider computer system over a secure Internet connection to enable the telemarketer to interact with the marketing and sales application. The telemarketer is provided with on-line access to the list of prospects in the database when the telemarketer is electronically appointed. At least one agent client computer system communicates with the item provider computer system over a secure Internet connection to enable the agent to interact with the marketing and sales application. The agent is provided with on-line access to a list of prospect leads in the database when the agent is electronically appointed. A method for targeted marketing of a product and/or service is also provided.

### FIELD OF THE INVENTION

The present invention relates generally to marketing and sales and in particular to an Internet-based marketing and sales application and to a method for targeted marketing of a product and/or service.

### BACKGROUND OF THE INVENTION

It is well known that marketing activities often translate directly into business opportunities. Although many businesses take advantage of changes in marketing techniques, some well established business sectors have failed to do so. The insurance industry is an example of such a business sector and has typically made use of a shotgun marketing approach to target potential prospects. During this approach, a service such as Dunn & Bradstreet is hired by an insurer to develop a list of potential prospects. The prospects in the list are passed along to a telemarketer who is responsible for calling the prospects to determine if they are interested in the insurance offered by the insurer. In many instances a significant number of prospects in the developed list are inappropriate. The costs associated with enlisting a telemarketer to call the prospects in the list can be significant. Thus, having lists of prospects with significant numbers of inappropriate prospects is problematic. Also, there is no control of data collected by the telemarketer relating to the called prospects. As will be appreciated there is a need for improved marketing and sales techniques in this and other business sectors.

It is therefore an object of the present invention to provide a novel marketing and sales application and method for targeted marketing of a product and/or service.

### SUMMARY OF THE INVENTION

Accordingly, in one aspect of the present invention there is provided a distributed computer network comprising:

an item provider computer system maintaining at least one campaign in a database, said at least one campaign identifying a list of prospects operating businesses in a common industry that are within a specified geographical area, said item provider computer system running a marketing and sales application, said marketing and sales application allowing an item provider user to electronically appoint a telemarketer for said at least one campaign and an agent for said at least one campaign;

at least one telemarketer client computer system communicating with said item provider computer system over a secure Internet connection to enable said telemarketer to interact with said marketing and sales application, said telemarketer being provided with on-line access to the list of prospects in said database when said telemarketer is electronically appointed; and

at least one agent client computer system communicating with said item provider computer system over a secure Internet connection to enable said agent to interact with said marketing and sales application, said agent being provided with on-line access to a list of prospect leads in said database when said agent is electronically appointed.

Preferably, the item provider computer system includes at least one web server and at least one database server. The at least one web server communicates with the at least one telemarketer client computer system and the at least one agent computer system. The at least one database server accesses the database in response to the at least one web server and provides data to the at least one web server for display by one or more of the at least one telemarketer client computer system and the at least one agent computer system. It is also preferred that the database maintains a plurality of different campaigns and the item provider computer system communicates with a plurality of telemarketer and agent client computer systems.

According to another aspect of the present invention there is provided an Internet-based marketing and sales application to facilitate targeted marketing of an item supplied by an item provider, said marketing and sales application comprising:

means for maintaining at least one campaign in a database, said campaign identifying a list of prospects operating businesses in a common industry that are within a specified geographical area;

means for appointing a telemarketer to said campaign electronically thereby to provide said telemarketer with on-line access to the list of prospects in said database, said telemarketer contacting the prospects in said list to enlist prospects potentially interested in purchasing said item (“actual prospects”); and

means for appointing an agent to said campaign electronically thereby to provide said agent with on-line access to a list of actual prospects, said appointed agent contacting the actual prospects in the list in an attempt to sell said item to said actual prospects.

According to another aspect of the present invention there is provided a method for targeted marketing of an item comprising the steps of:

establishing a campaign for said item, said campaign identifying a list of prospects within a specified geographical region;

appointing an agent to said campaign;

appointing a telemarketer to said campaign, said telemarketer contacting the prospects in said list to determine prospects potentially interested in said item (“actual prospects”); and

providing said appointed agent with a list of the actual prospects, said appointed agent contacting the actual prospects in an attempt to sell said item to said actual prospects.

Preferably, during the establishing the list of prospects is cleaned to remove prospects who are already either clients of the item provider and/or clients of the appointed agent. It is also preferred that the prospects in the list operate businesses in a particular industry sector. During the establishing, the list of prospects is developed using a plurality of resources. Initially the list of prospects is developed using a plurality of list resources and is then expanded using Internet searches, library resources and/or other research.

Preferably, the method further includes the step of forwarding mailers to the prospects in the list prior to the telemarketer contacting the prospects. It is also preferred that additional mailers are forwarded to the actual prospects prior to the appointed agent contacting the actual prospects. The additional mailers provide an indication to the actual prospects as to when they can expect to be contacted by the appointed agent.

According to yet another aspect of the present invention there is provided a method for targeted marketing of insurance offered by an insurer comprising the steps of:

establishing a campaign for said insurance, said campaign identifying a list of prospects within a specified geographical region that operate businesses in a particular industry sector;

appointing a broker to said campaign;

appointing a telemarketer to said campaign, said telemarketer contacting the prospects in said list to enlist prospects potentially interested in said insurance (“actual prospects”); and

providing said appointed broker with a list of the actual prospects, said appointed broker contacting the actual prospects in an attempt to sell said insurance to said actual prospects.

According to yet another aspect of the present invention there is provided an Internet-based method for targeted marketing of an item supplied by an item provider, said method comprising the steps of:

maintaining at least one campaign in a database, said campaign identifying a list of prospects operating businesses in a common industry that are within a specified geographical area;

appointing a telemarketer to said campaign electronically thereby to provide said telemarketer with on-line access to the list of prospects in said database, said telemarketer contacting the prospects in said list to enlist prospects potentially interested in purchasing said item (“actual prospects”); and

appointing an agent to said campaign electronically thereby to provide said agent with on-line access to a list of actual prospects, said appointed agent contacting the actual prospects in the list in an attempt to sell said item to said actual prospects.

According to still yet another aspect of the present invention there is provided a method for targeted marketing of an item supplied by an item provider comprising the steps of:

performing, by the item provider, initial prospecting to identify a list of prospects for the item; and

providing targeted leads to an agent associated with the item provider to enable the agent to contact selected prospects in the list in an attempt to sell said item.

The present invention provides advantages in that the marketing and sales application provides targeted leads, marketing support and sales management to brokers having expertise in selected classes of business. By providing targeted leads to brokers, the need for brokers to prospect for business is reduced allowing brokers to focus on their primary business concerns. The present invention also provides advantages in that prospect targeting can be monitored closely allowing timely feedback and faster turnaround of leads. In addition, the present invention provides advantages in that collected data relating to prospects is controlled and can be used to develop long-term statistics allowing successful programs to be easily identified in terms of telemarketer and broker performance. Loss ratio and attrition can also be monitored.

### BRIEF DESCRIPTION OF THE DRAWINGS

An embodiment of the present invention will now be described more fully with reference to the accompanying drawings in which:

FIGS. 1a to 1c are flowcharts showing the steps performed during the present method for targeted marketing of a product and/or service in accordance with the present invention;

FIGS. 2a to 2c show an exemplary marketing material mailer;

FIG. 3 is an exemplary script used by a telemarketer during performance of the method of FIGS. 1a to 1c.

FIG. 4 is an exemplary lead sheet used by a telemarketer during performance of the method of FIG. 1a to 1c.

FIG. 5 shows an exemplary thank you letter mailer;

FIG. 6 is a schematic block diagram of a database structure;

FIG. 7 is a diagram illustrating a distributed computer architecture including an insurer computer system, a telemarketer computer system and broker computer systems communicating over the Internet;

FIGS. 8a to 8gg are screen shots of web pages accessible to an administrator user accessing a marketing and sales application running on the insurer computer system illustrated in FIG. 7;

FIGS. 9a to 9g are screen shots of web pages accessible to a telemarketer user accessing the marketing and sales application; and

FIGS. 10a to 10o are screen shots of web pages accessible to a broker user accessing the marketing and sales application.

### DETAILED DESCRIPTION OF THE PREFERRED EMBODIMENT

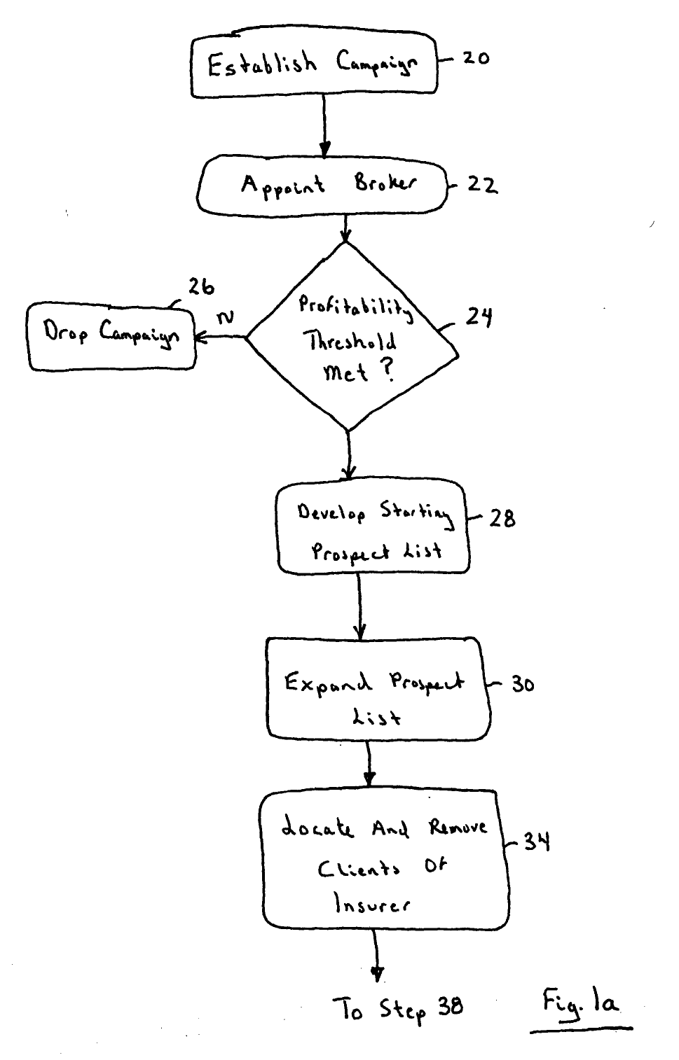

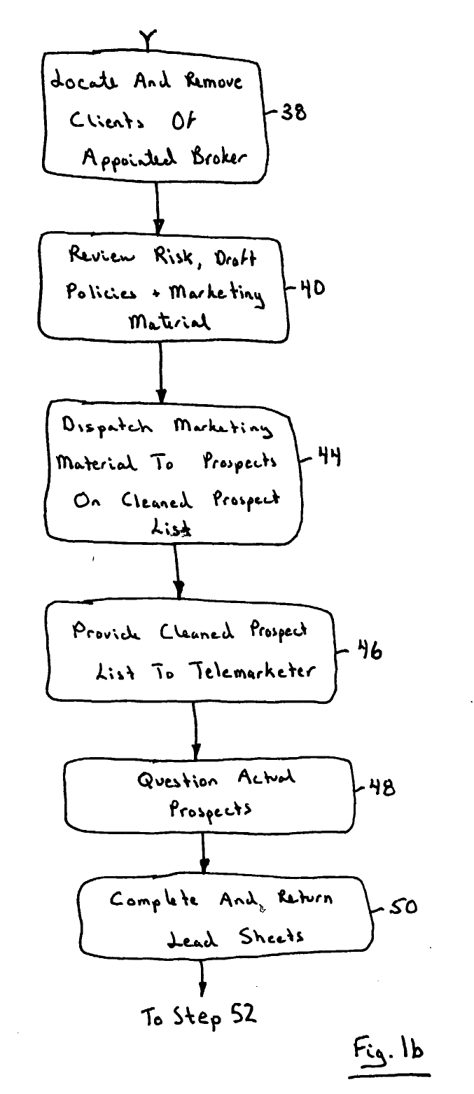

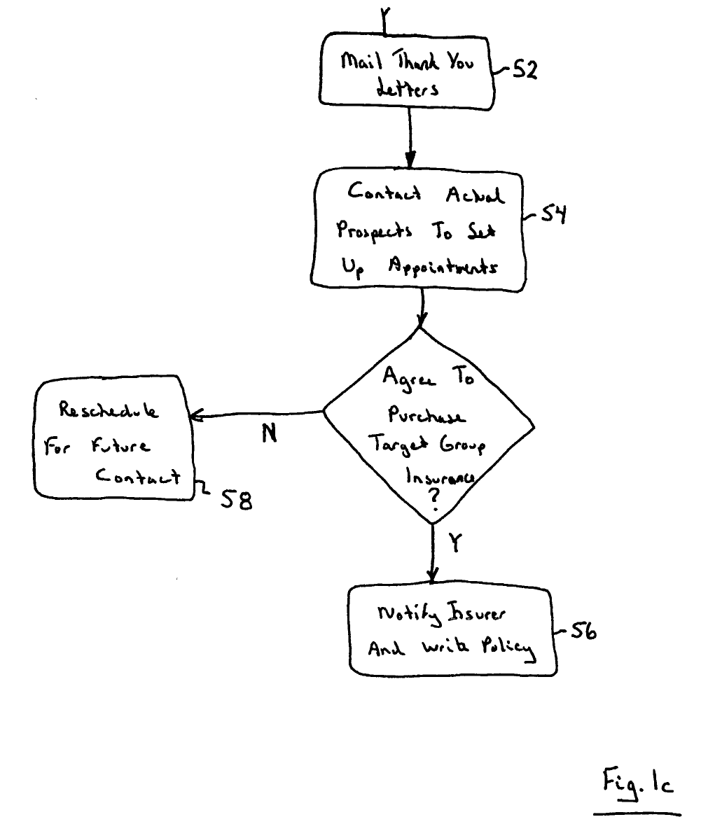

The present invention relates to an Internet-based marketing and sales application and to a method for targeted marketing of a product and/or service (herein referred generically to as “marketed item”). During the method, a campaign for the item is established. The campaign identifies a list of prospects within a specified geographical region. An agent and a telemarketer are appointed to the campaign. The telemarketer contacts the prospects in the list to determine the prospects potentially interested in the item (“actual prospects”). The appointed agent is provided with a list of the actual prospects so that the appointed agent may contact the actual prospects in an attempt to sell the item to the actual prospects. As will be appreciated, by providing the appointed agent with a list of actual prospects, the appointed agent is given targeted leads. In the preferred embodiment, the marketed item is insurance. As mentioned previously, the insurance industry has been slow to change marketing techniques used to offer insurance to prospective clients (“prospects”). According to the present invention a novel method for targeted marketing of insurance has been developed and will now be generally described with particular reference to FIGS. 1a to 1c.

Initially, a campaign for marketing and selling insurance to a particular target group within a specified geographical region is conceived by the insurer (step 20). The target group relates to a particular industry sector and will typically include a plurality of prospects operating businesses within the specified geographical region. Once the target group of the campaign is determined, a broker for that particular target group is appointed by the insurer (step 22). The target group and appointed broker are then verified to ensure they are profitable (step 24). A number of different brokers may be considered during step 22 before the profitability threshold of step 24 is met. If a profitable target group and broker combination for the campaign cannot be determined at step 24, the campaign is dropped (step 26). After a profitable target group and broker combination is determined at step 24, a starting prospect list for the campaign is developed that includes potential prospects in the target group (step 28). The starting prospect list is developed using a number of list resources such as Info Canada, Dunn & Bradstreet, association lists, brokers lists and other list sources that identify potential prospects within the specified geographical region. The prospect list identifies the prospects by name, address and other relevant information available.

Once the starting prospect list has been completed, the starting prospect list is expanded using Internet searches, library resources and/or other research (step 30). The expanded prospect list is then run through a two-stage cleaning process. During the first cleaning stage, the expanded prospect list is examined to locate and remove listed prospects that are already clients of the insurer (step 34). During the second cleaning stage, the modified prospect list is examined to locate and remove listed prospects that are already clients of the appointed broker (step 38). Prospects deleted from the expanded prospect list of course, create a starting market for the target group insurance. With the prospect list cleaned, underwriters of the insurer review the risks associated with the target group and draft policies and marketing material (step 40).

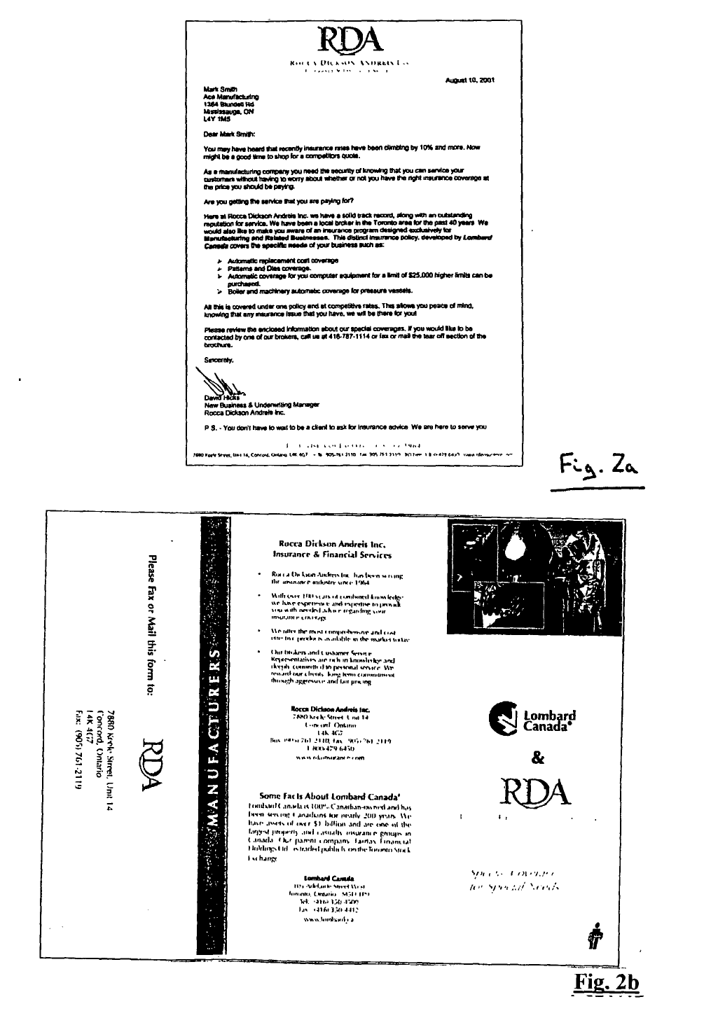

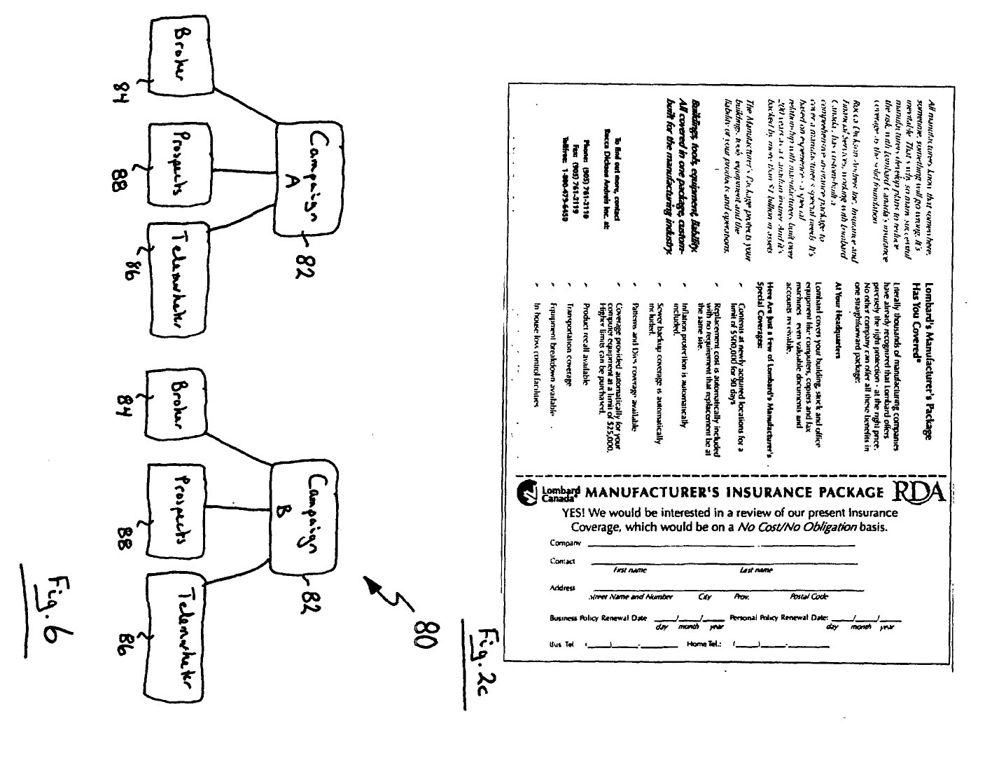

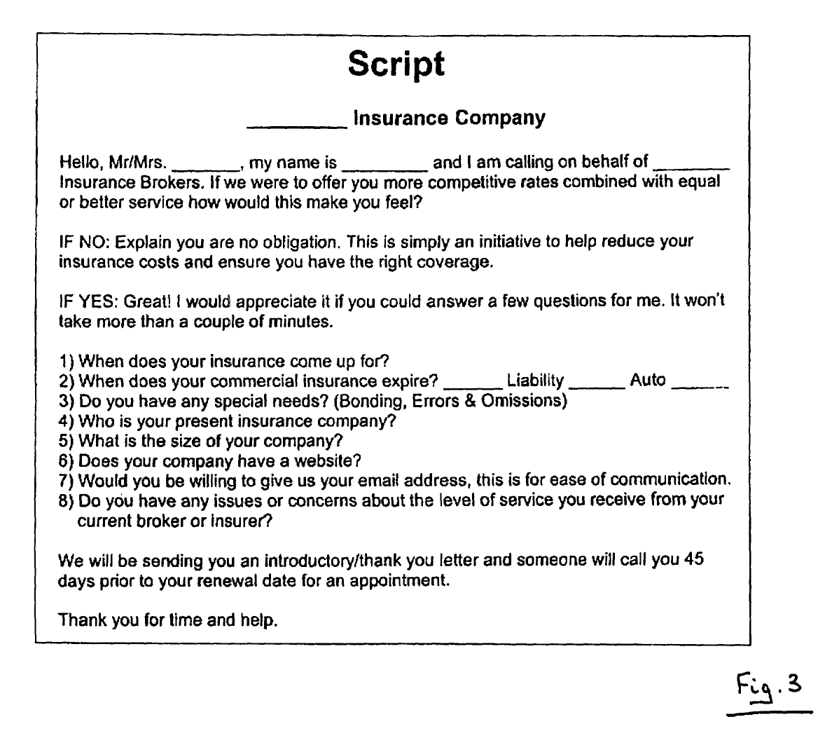

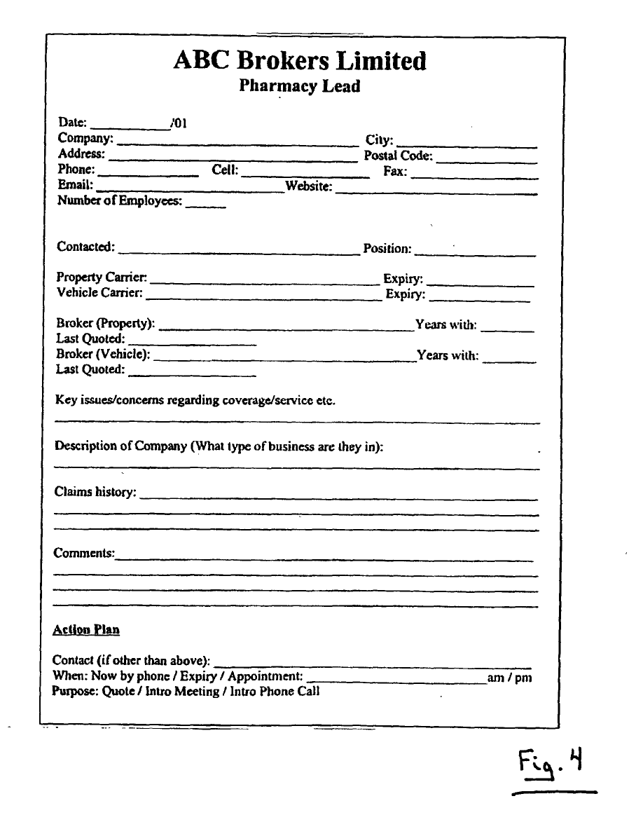

Following step 40, a three stage marketing process is performed. Initially, marketing material is mailed directly to the prospects on the cleaned prospect list (step 44). The marketing material is generated and mailed by the insurer but is on the letterhead of the appointed broker. FIGS. 2a to 2c show an exemplary marketing material mailer.

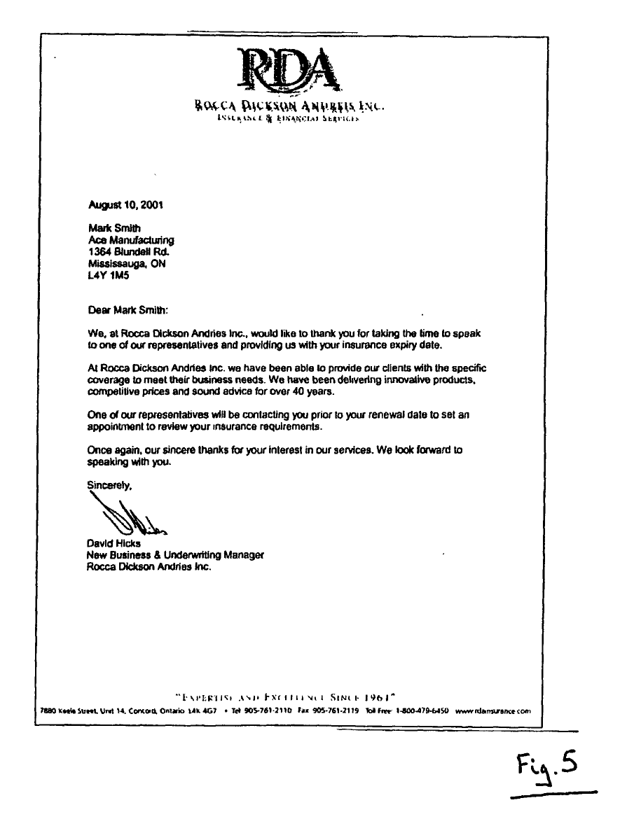

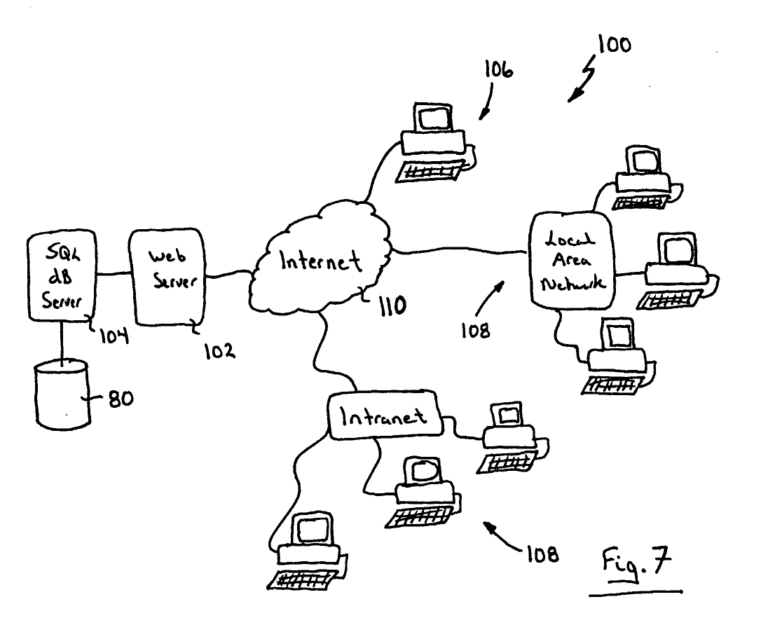

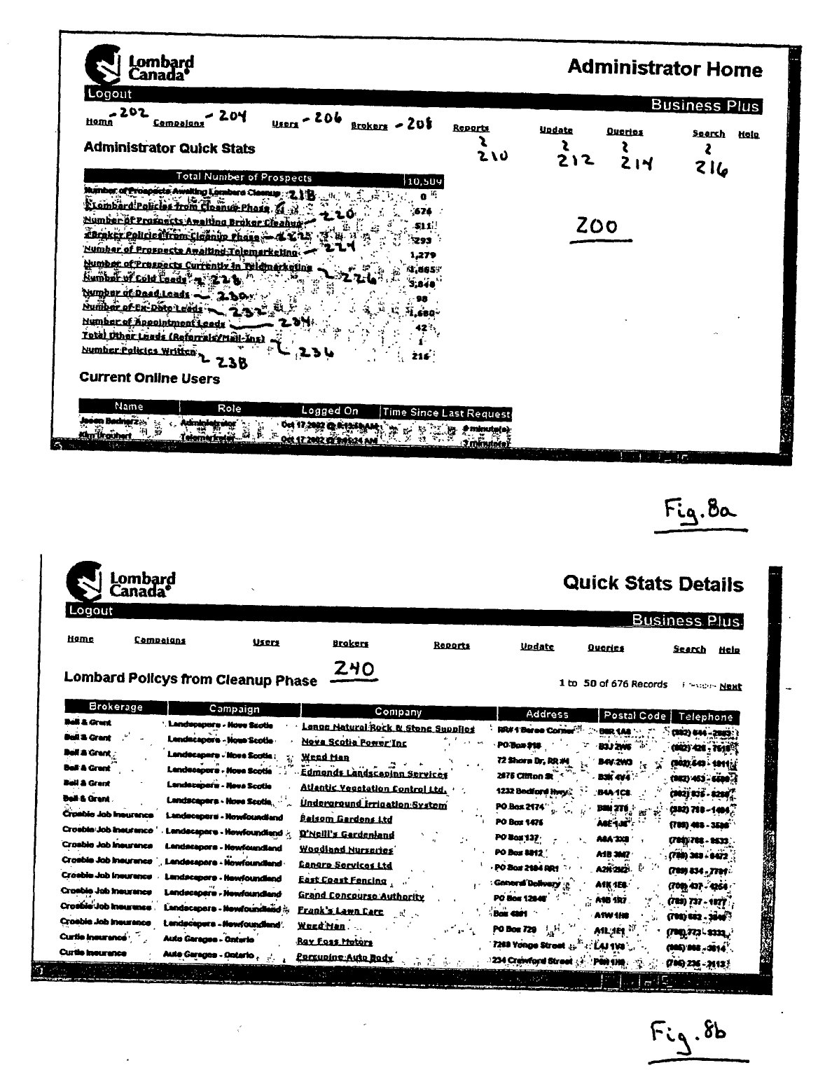

After the marketing material has been mailed, the cleaned prospect list is given to an appointed telemarketer (step 46). The appointed telemarketer in turn contacts the prospects on the cleaned prospect list to determine which prospects on the cleaned prospect list are prospects that are actually interested in the target group insurance (“actual prospects”). Actual prospects are asked a series of questions following a script such as that shown in FIG. 3 (step 48). Lead sheets are completed by the telemarketer based on the information gathered in response to the series of questions as shown in FIG. 4. The completed lead sheets are returned to the insurer allowing the insurer to identify the actual prospects listed on the cleaned prospect list (step 50). The collected data is also used to enhance the information in the prospect list allowing more detailed information concerning prospects to be maintained. Thank you letters are then generated and mailed to the actual prospects by the insurer but on the letterhead of the appointed broker (step 52). The thank you letters inform the actual prospects that they will be contacted by the appointed broker a fixed number of days prior to the expiry date (ex-date) of their current insurance policy. An exemplary thank you letter mailer is shown in FIG. 5.

Once the telemarketing has been completed and with the actual prospects from the cleaned prospect list are known, the appointed broker is provided with the list of actual prospects (i.e. targeted leads) so that the appointed broker may contact the actual prospects at the appropriate times to set up appointments (step 54). In this manner, producers employed by the appointed broker may meet with the actual prospects in an attempt to sell the actual prospects the target group insurance. When an actual prospect agrees to purchase the target group insurance, the insurer is notified so that a policy may be written (step 56). If a policy for the prospect is written, the policy information is added to the data associated with the prospect. If the actual prospect declines to purchase the target group insurance, depending on the reason for declining the target group insurance, the actual prospect may be contacted in the future if the actual prospect is considered to be a cold lead (step 58). Prospects that are considered to be dead leads are not pursued further.

To facilitate performing the above method, an Internet-based marketing and sales application is maintained by the insurer and is accessible to telemarketers and appointed brokers over the Internet. The marketing and sales application data is maintained in a database 80 (see FIG. 6) and includes data relating to all campaigns 82 being pursued by the insurer, the broker 84 appointed to each campaign 80, the telemarketer 86 appointed to each campaign 80 and the prospects 88 (both cleaned and actual) associated with each campaign 80.

Specifically, the database stores a profile for each campaign being pursued by the insurer, a profile for each broker appointed to a campaign and a profile for each prospect associated with each campaign. Each campaign profile identifies the campaign by target group, target area identifying the specified geographical region, campaign description, the broker appointed to the campaign, the campaign start date, the campaign end date and general commentary.

Each broker profile identifies the broker name, the broker agency number, and contact information.

Each prospect profile identifies the prospect by name, contact information, ex-date if the prospect has not been sold insurance and policy number if the prospect has been sold insurance.

Turning now to FIG. 7, a distributed computer architecture supporting the marketing and sales application is shown and is generally identified by reference numeral 100. Computer architecture 100 includes an IIS web server 102 and a SQL database server 104 located at the insurer's business location. The web server 102 runs the Internet-based marketing and sales application, which includes active server page (ASP) files containing code written in Visual Basic (VB) script, Java script and Hypertext Markup Language (HTML). The SQL database sever 104 supports the SQL database 80 that acts as the backend repository for the marketing and sales application data. A telemarketer client computer system 106 and broker client computer systems 108 communicate with the web server 102 over the Internet 110 via web browsers running on the client computer systems 106 and 108. As is well known, the Internet 110 provides a backbone of high-speed data communication lines between host computers that route data and messages using the Transmission Control Protocol/Internet Protocol (TCP/IP) suite of protocols. The telemarketer client computer system 106 and the broker client computer systems 108 may be standalone personal computers, local area networks or Intranets.

During communications between the web server 102 and the client computer systems 106 and 108, the web server 102 sends ASP files to the client computer systems 106 and 108 in response to requests generated by the web browsers. The ASP files received by the client computer systems 106 and 108 cause the web browsers to display formatted web pages to the users of the client computer systems 106 and 108. This enables users to access and interact with the marketing and sales application through a web-based graphical user interface (GUI). Although only one telemarketer client computer system 106 and two broker client computer systems 108 are shown, those of skill in the art will appreciate that this is for ease of illustration only. The web server 102 may of course communicate with virtually any number of telemarketer client computer systems 106 and broker client computer systems 108.

As mentioned above, the marketing and sales application supports and is used extensively during performance of the above-described method for targeted marketing of an item. Data in the database 80 that is relevant to the telemarketers and appointed brokers is made accessible to them via web browsers over secure Internet connections. Data in the database 80 that is relevant to the insurer is similarly accessible via web browsers over secure Intranet connections. As is common, the marketing and sales application provides for staged access to data in the database 80 based on assigned user security level. At the administrator level, unrestricted access to data in the database 80 is permitted. Various other security levels ranging from significant data access to read only access are also provided for; however, since this type of staged security data access is well known and unrelated to the present invention, further specifics will not be described herein.

During performance of the method of FIGS. 1a to 1c, once it is verified that the target group and appointed broker for a campaign are profitable, the campaign is entered into the marketing and sales application by completing a formatted web page. Once saved, the campaign profile is stored in the database 80. The prospects on the expanded prospect list associated with the campaign are also entered into the marketing and sales application by completing formatted web pages. Once saved, the prospect profiles are stored in the database 80.

Once the expanded prospect list has been cleaned to remove existing clients of the insurer and the broker at steps 34 and 38, the marketing and sales application is conditioned to generate automatically a marketing material mailer similar to that shown in FIGS. 2a to 2c, for each of the prospects on the cleaned prospect list.

The marketing and sales application is also used to select the telemarketer to be used during the campaign via a formatted web page. Once the telemarketer has been selected, the marketing and sales application permits the selected telemarketer to access relevant prospect data thereby to enable the telemarketer to contact and question the prospects on the cleaned prospect list.

The marketing and sales application permits the telemarketer to input data to the marketing and sales application based on the questionnaire results so that the marketing and sales application can identify the actual prospects in real time and automatically generate the thank you letter mailers shown in FIG. 5.

Once the actual prospects are known and identified by the marketing and sales application, the marketing and sales application permits the appointed broker to access relevant prospect data thereby to enable producers of the appointed broker to contact the actual prospects in an attempt to sell the target group insurance.

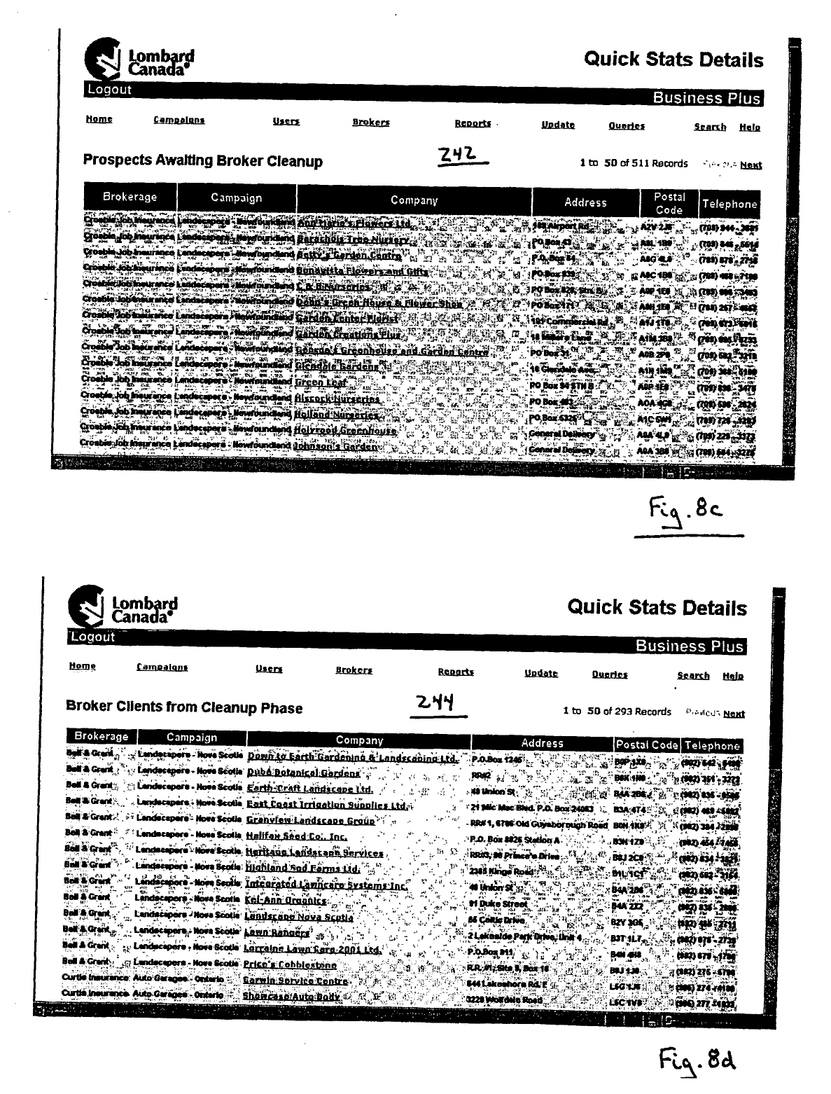

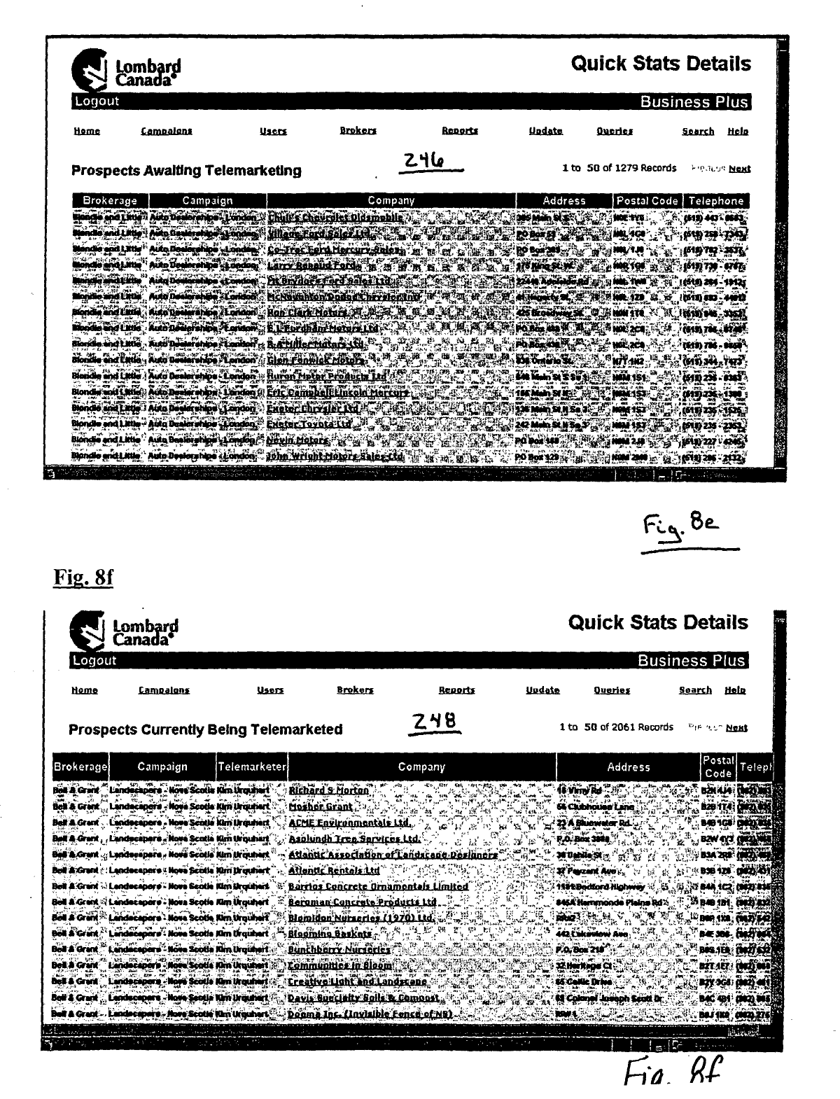

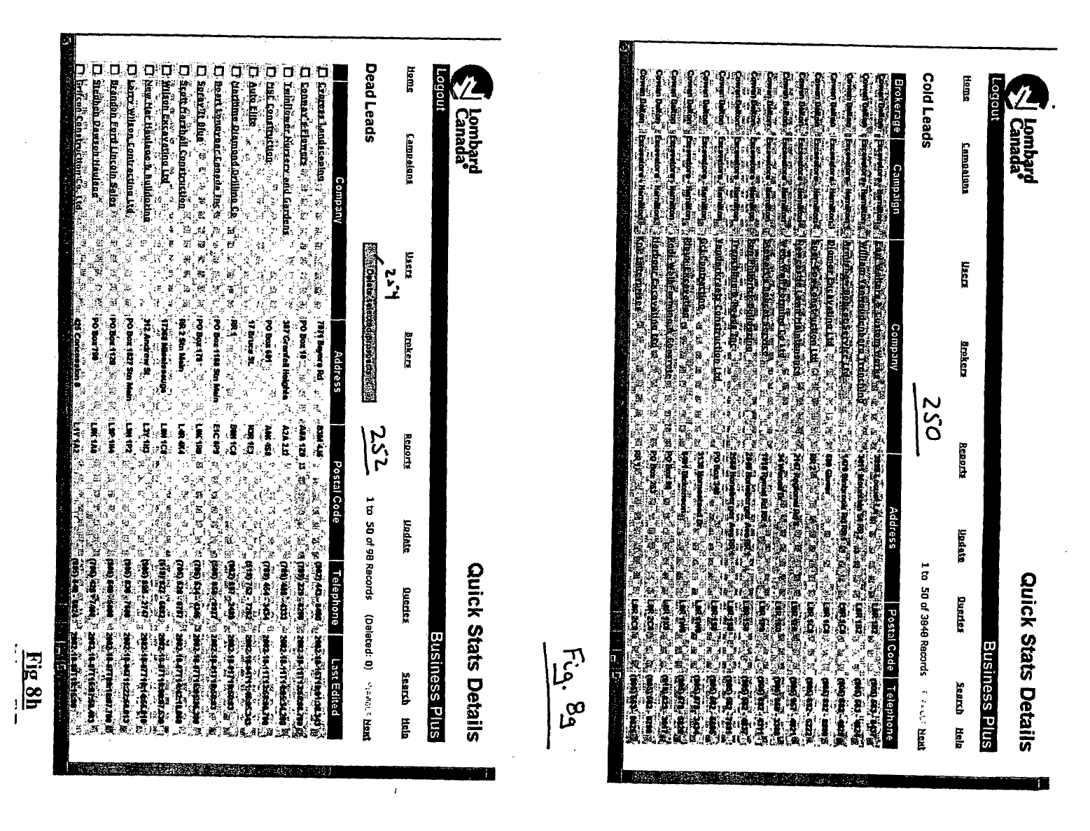

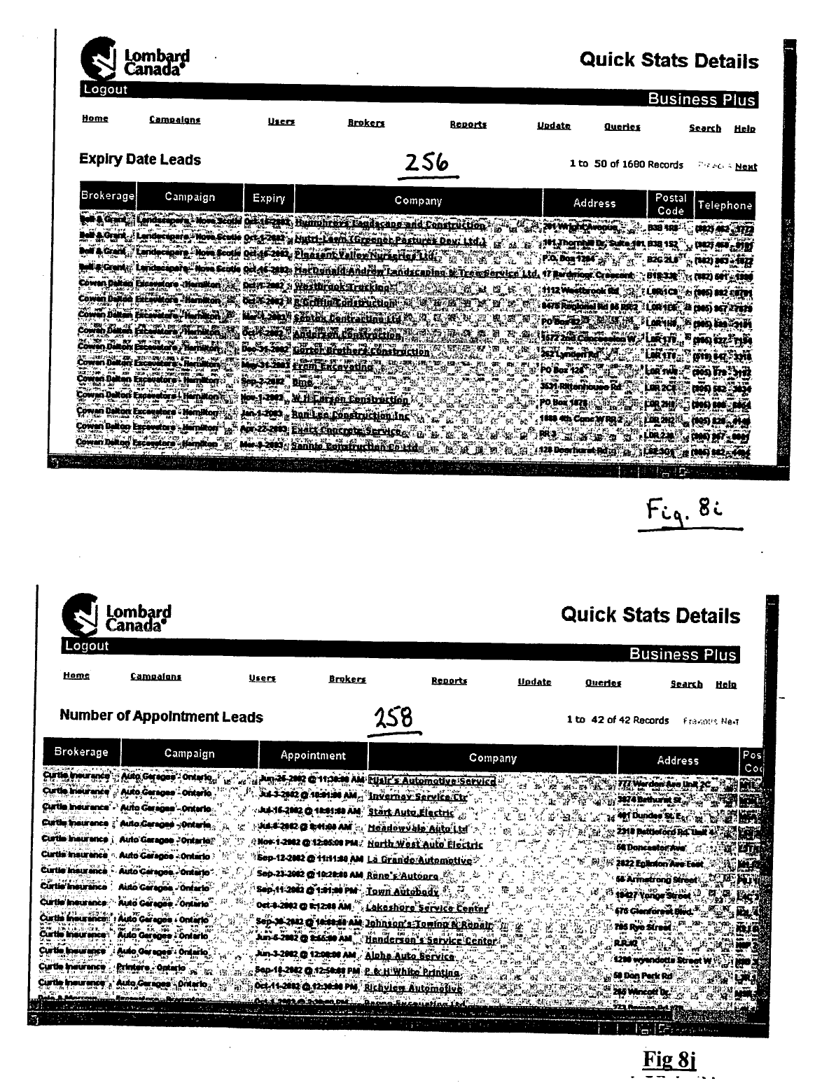

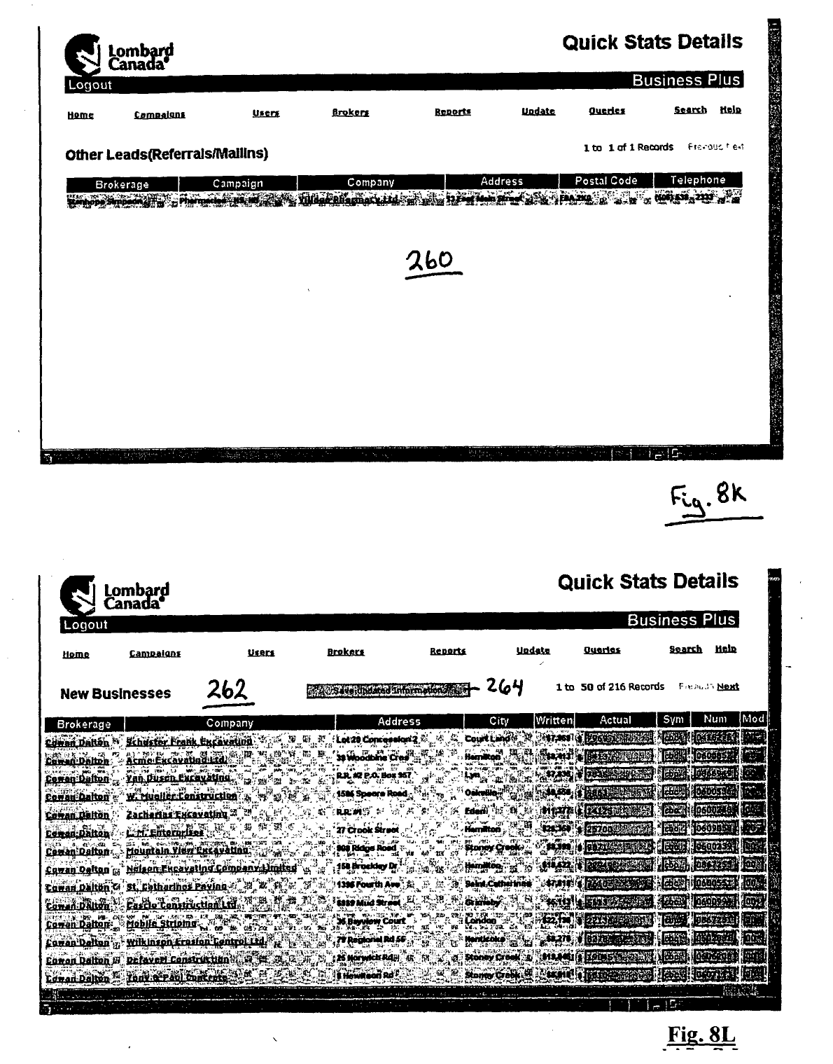

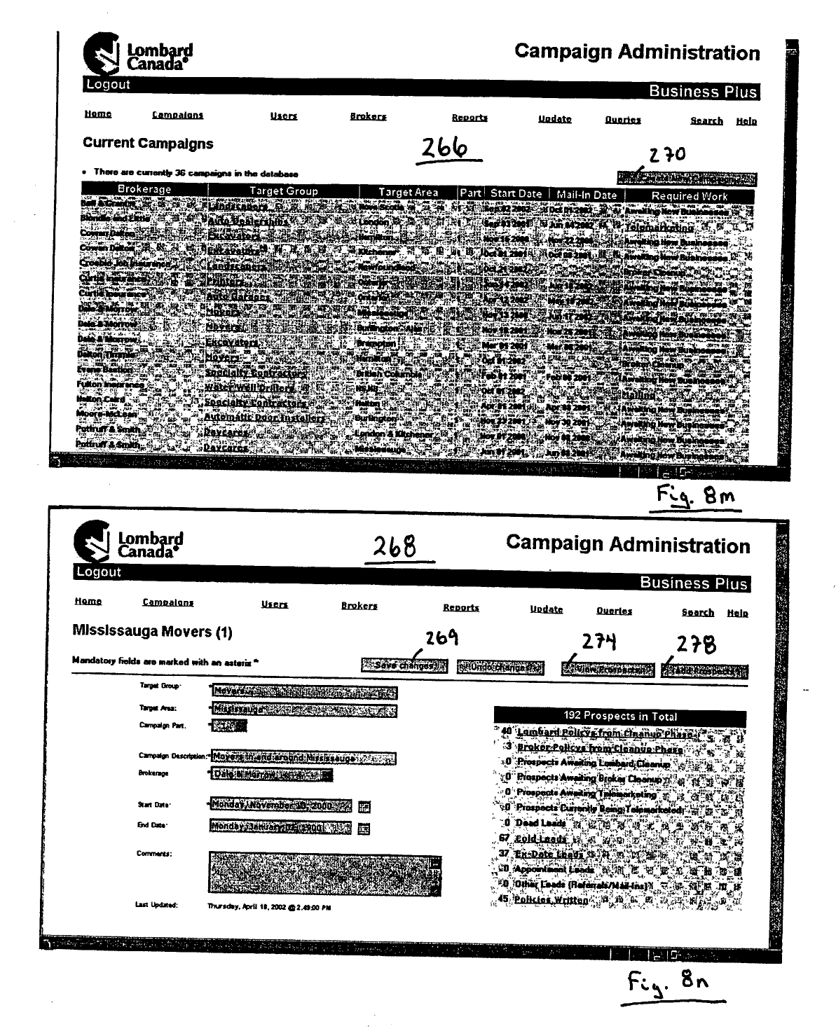

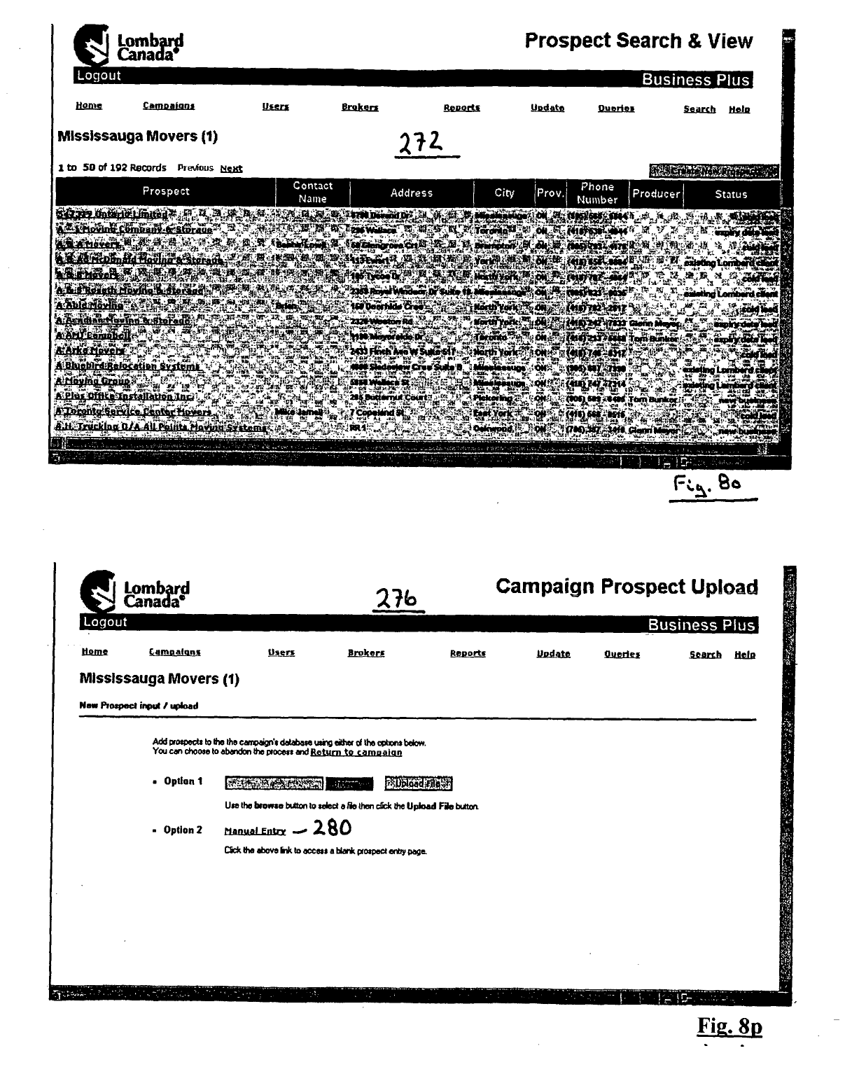

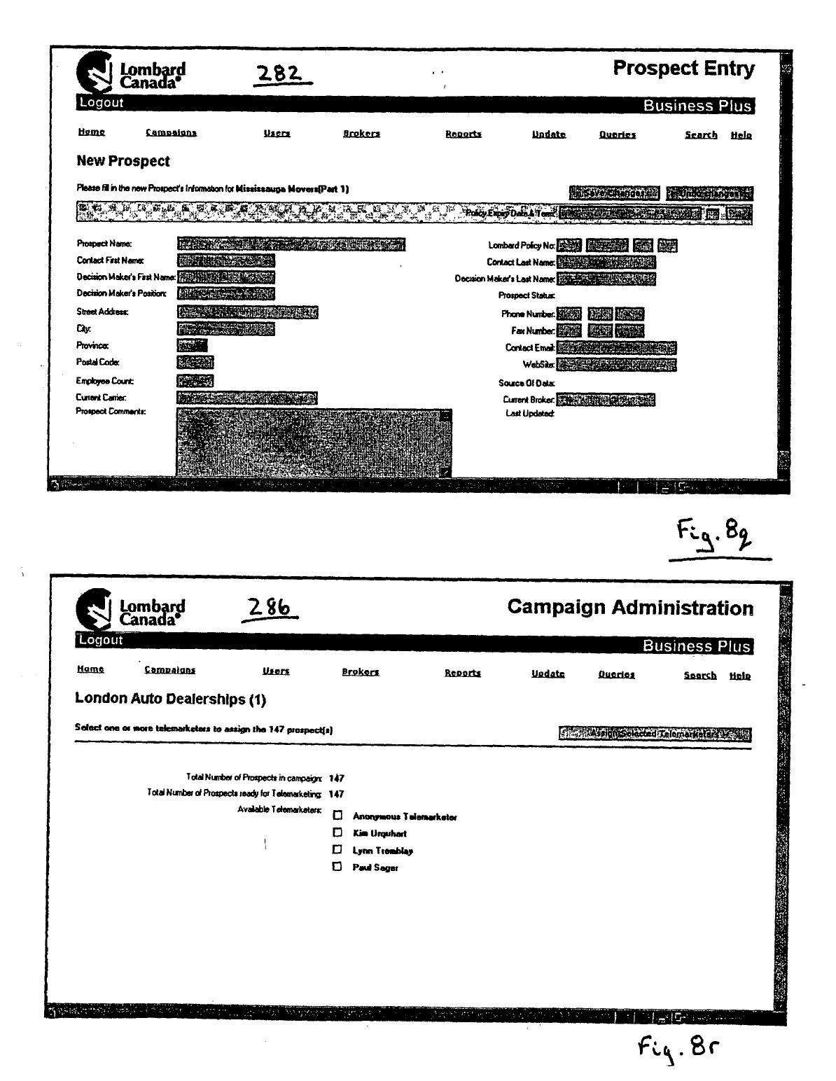

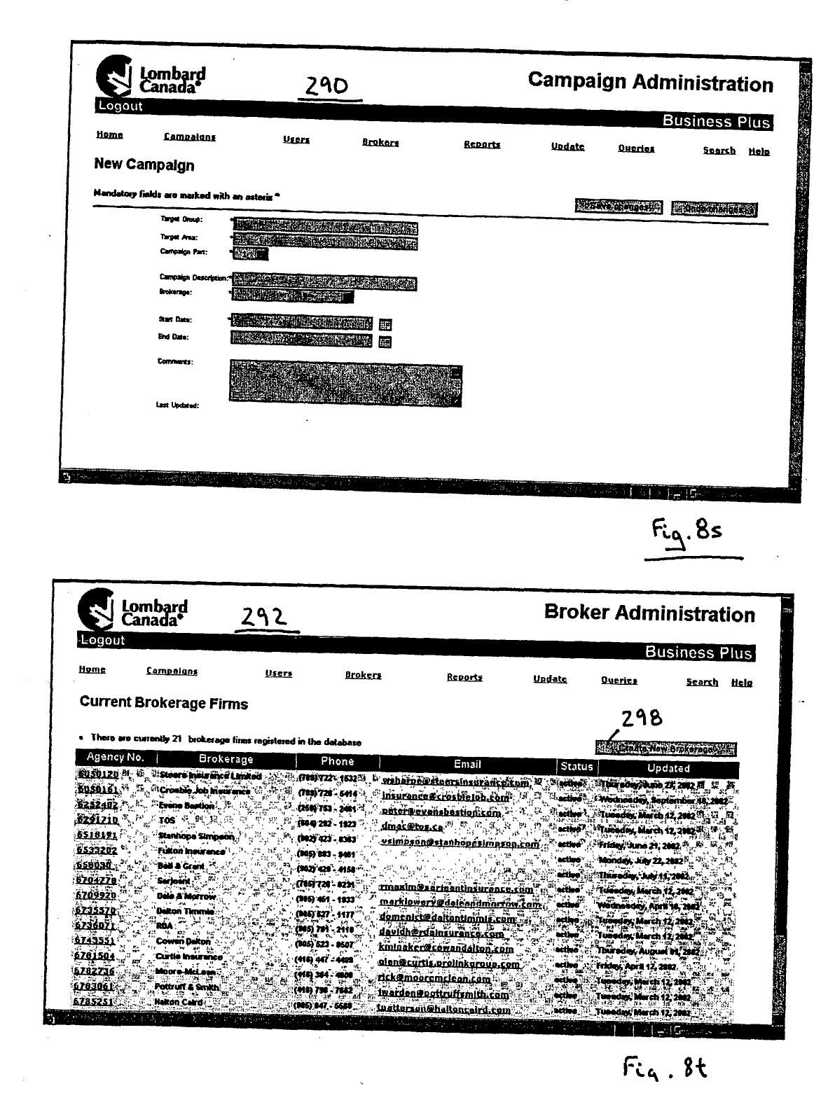

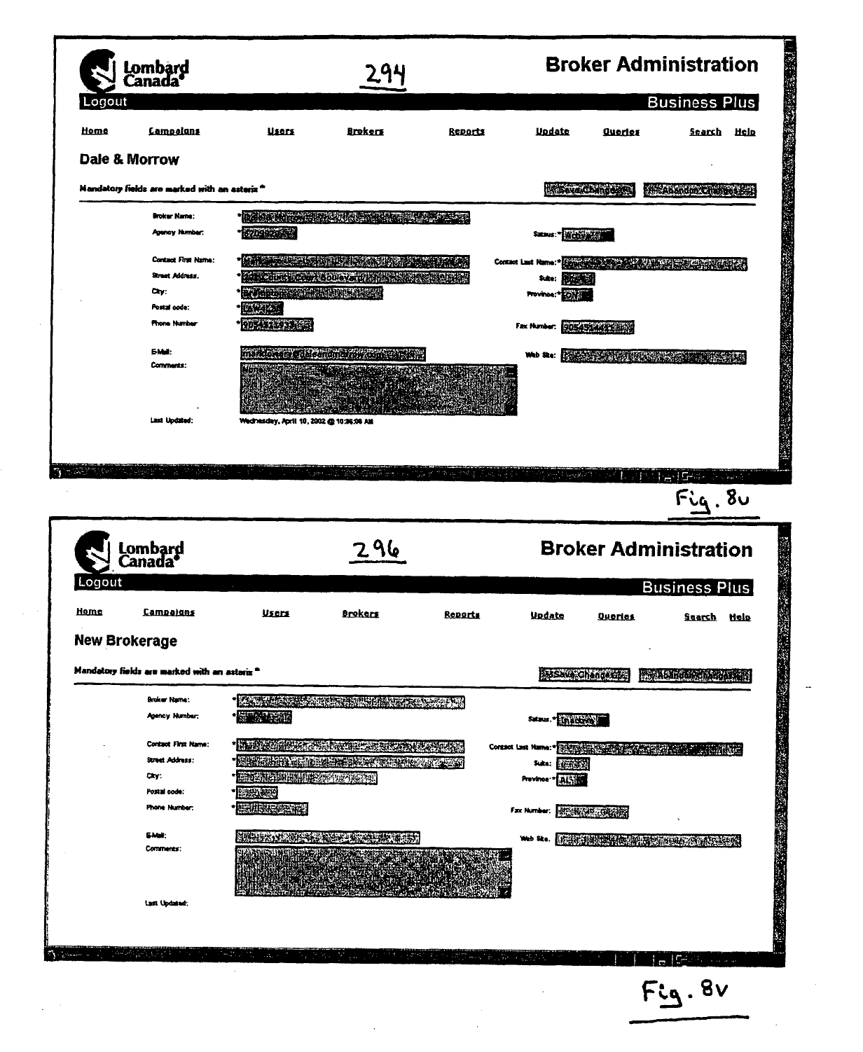

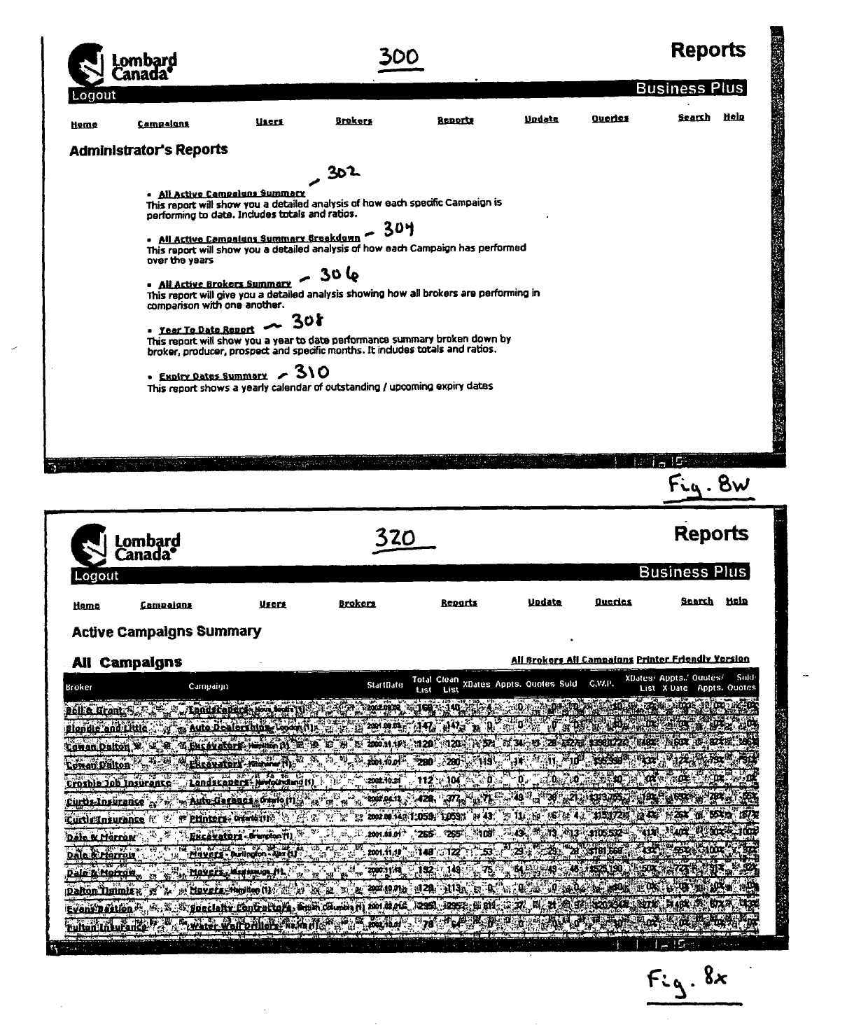

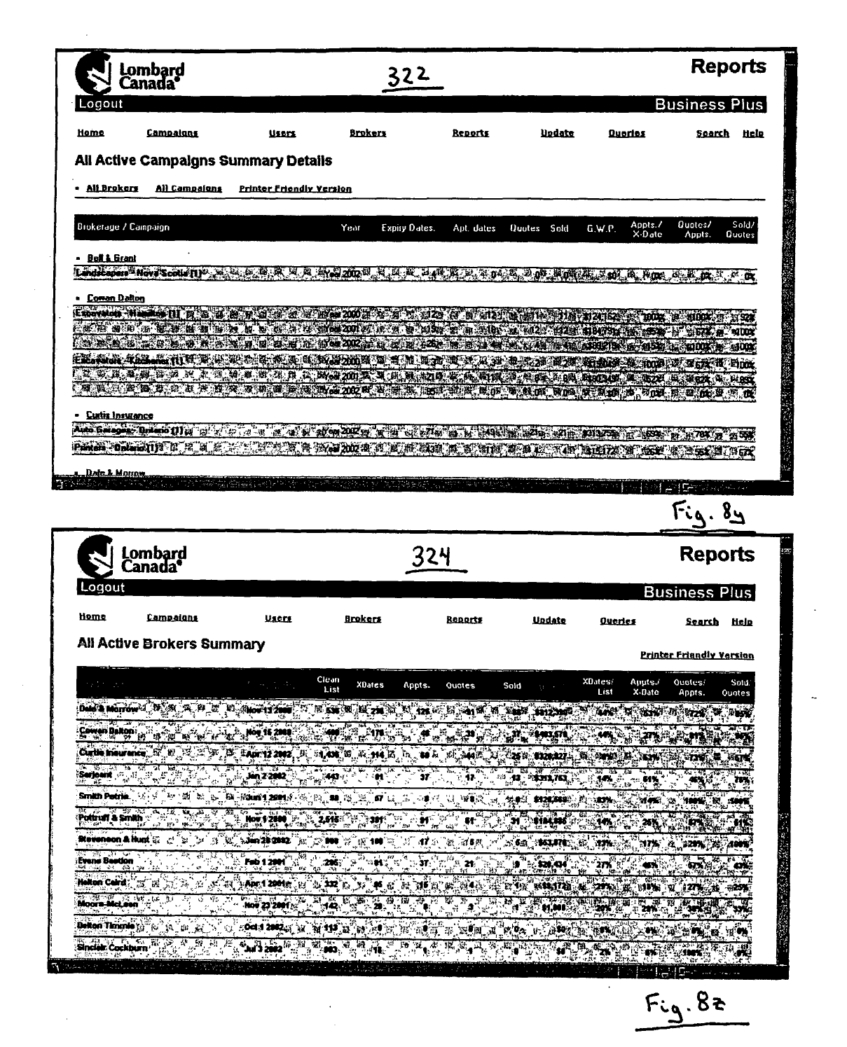

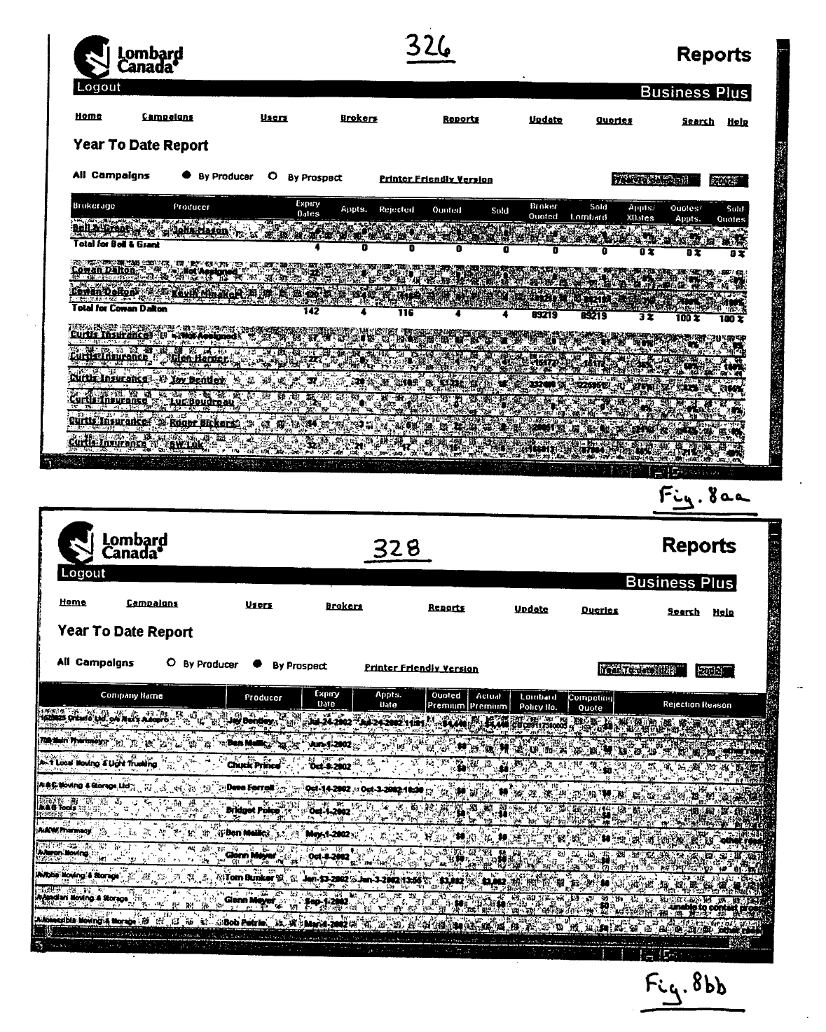

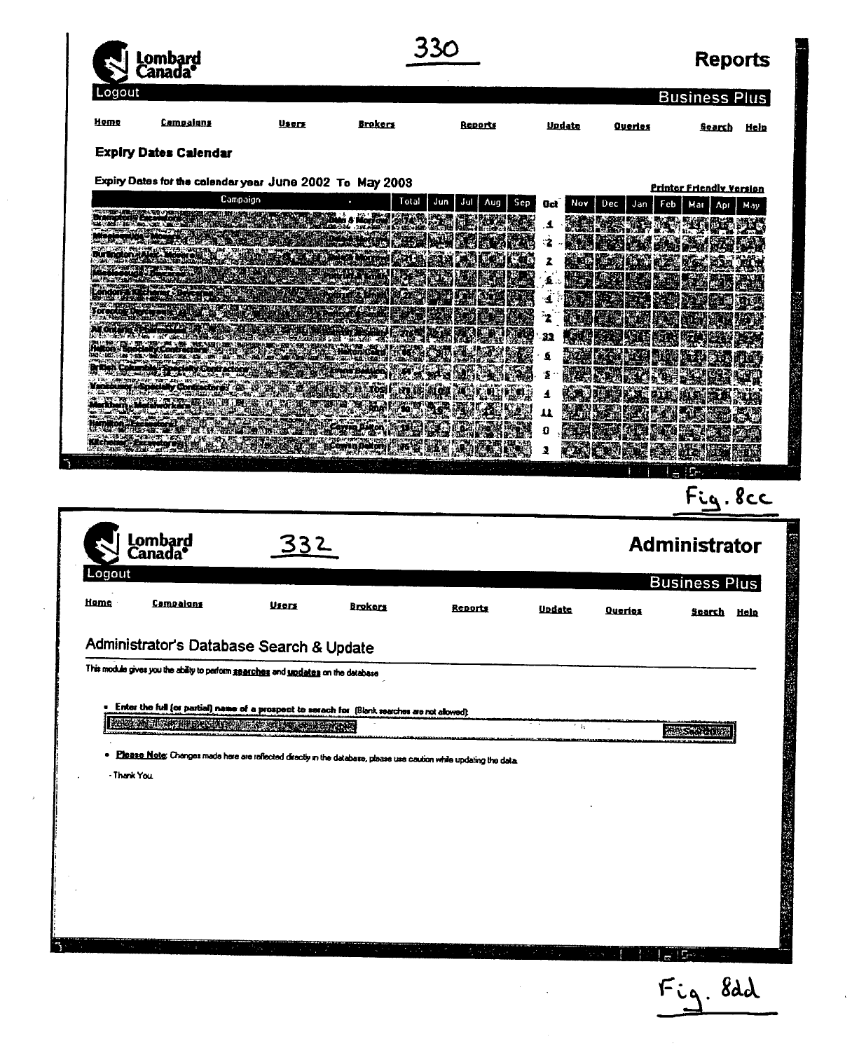

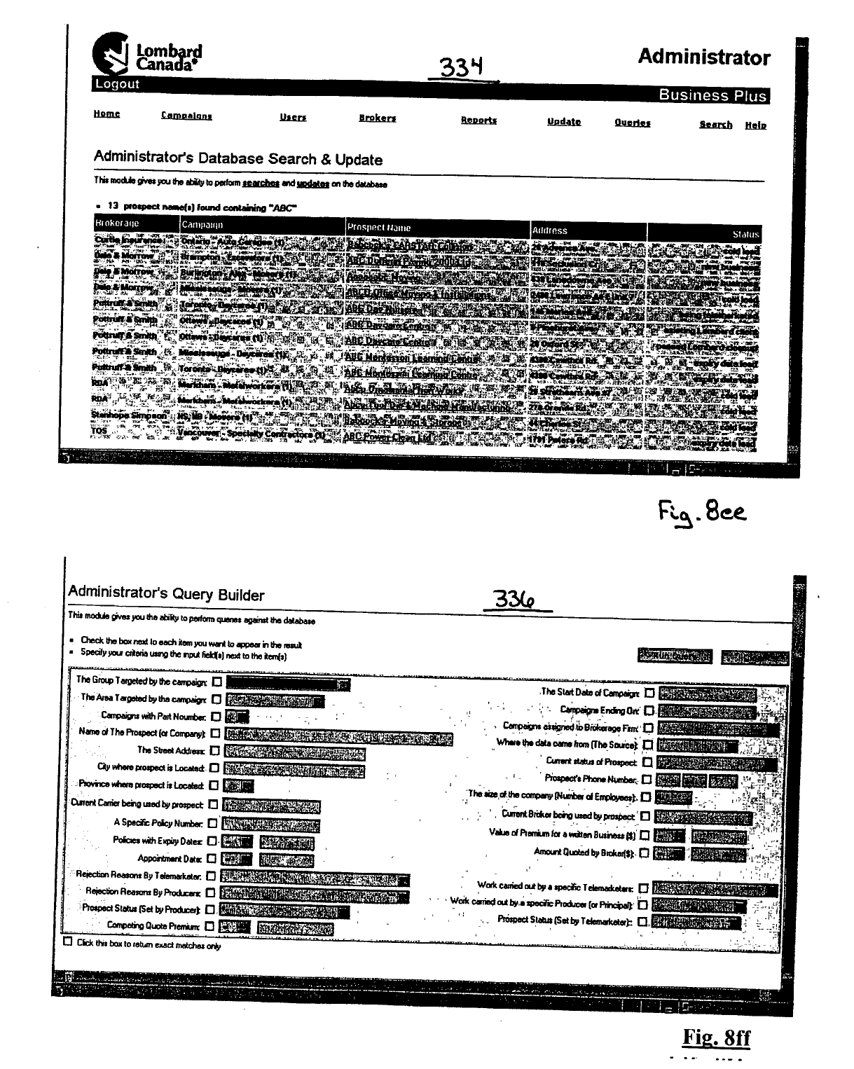

The graphical user interface of the marketing and sales application that exposes data in the database 80 to the insurer (administration level), the appointed broker and the appointed telemarketer and provides for the above-described functionality will now be described with particular reference to FIGS. 8a to 10o.

Insurer Web Pages

FIG. 8a shows the administrator home web page 200 that is presented to the administrator user when the user logs into the marketing and sales application. As can be seen, a series of hyperlinks are provided across the top of the web page 200, namely a home hyperlink 202, a campaigns hyperlink 204, a users hyperlink 206, a brokers hyperlink 208, a reports hyperlink 210, an updates hyperlink 212, a queries hyperlink 214 and a search hyperlink 216. The home hyperlink 202 is linked to the administrator home web page 200. The remaining hyperlinks 204 to 216 are linked to other web pages as will be described. The hyperlinks 202 to 216 appear across the top of each of the insurer web pages to facilitate navigation. In addition to the above described hyperlinks, the administrator home web page 200 lists the total number of prospects and the total number of online users accessing the marketing and sales application. The total number of prospects for all campaigns being pursued by the insurer is broken down into a variety of categories. These categories include the number of prospects awaiting insurer cleanup, the number of prospects identified as clients of the insurer during cleanup, the number of prospects awaiting broker cleanup, the number of prospects identified as clients of brokers during cleanup, the number of prospects awaiting telemarketing, the number of prospects currently in telemarketing, the number of prospects considered to be cold leads, the number of prospects considered to be dead leads, the number of ex-date leads, the number of appointment leads, the total other leads and the number of policies written. With the exception of the number of prospects awaiting insurer cleanup, the prospect categories are presented as hyperlinks 218 to 238 linked to quick statistics detail web pages.

FIG. 8b shows the quick statistics detail web page 240 that is linked to hyperlink 218. As can be seen, web page 240 lists the prospects that are identified as being existing clients of the insurer during the first cleaning stage (step 34). Each identified prospect is presented as a hyperlink linked to an associated prospect web page similar to that shown in FIG. 8p that exposes the prospect's profile.

FIG. 8c shows the quick statistics detail web page 242 that is linked to hyperlink 220. Web page 242 presents a list of prospects awaiting cleanup by brokers. Each identified prospect is presented as a hyperlink linked to an associated prospect web page.

FIG. 8d shows the quick statistics detail web page 244 that is linked to hyperlink 222. As can be seen, web page 244 lists the prospects that are identified as being existing clients of the brokers during the second cleaning stage (step 38). Each identified prospect is presented as a hyperlink linked to an associated prospect web page.

FIG. 8e shows the quick statistics detail web page 246 that is linked to the hyperlink 224. Web page 246 presents a list of the prospects awaiting telemarketing. The prospects are listed together with their assigned brokers and associated campaigns. Each identified prospect is presented as a hyperlink linked to an associated prospect web page.

FIG. 8f shows the quick statistics detail web page 248 that is linked to the hyperlink 226. Web page 248 presents a list of the prospects currently in telemarketing. Similar to web page 246, the prospects are listed together with their assigned brokers and associated campaigns. Each identified prospect is presented as a hyperlink linked to an associated prospect web page.

FIG. 8g shows the quick statistics detail web page 250 that is linked to hyperlink 228. Web page 250 lists prospects considered to be cold leads. Similar to web pages 246 and 248, the prospects are listed together with their assigned brokers and associated campaigns. Each identified prospect is presented as a hyperlink linked to an associated prospect web page.

FIG. 8h shows the quick statistics detail web page 252 that is linked to hyperlink 230. Web page 252 lists prospects considered to be dead leads together with contact information. A select box is associated with each prospect allowing the prospect to be selected and removed from the list by clicking on the delete bar 254. Each identified prospect is presented as a hyperlink linked to an associated prospect web page.

FIG. 8i shows the quick statistics detail web page 256 that is linked to hyperlink 232. Web page 256 lists the prospects from whom ex-date information has been acquired. The prospects are listed together with their assigned brokers, campaigns and ex-dates. Each identified prospect is presented as a hyperlink linked to an associated prospect web page.

FIG. 8j shows the quick statistics detail web page 258 that is linked to hyperlink 234. Web page 258 lists the prospects with whom appointments have been set up. The prospects are listed together with their assigned brokers, campaigns and appointment times and dates. Each identified prospect is presented as a hyperlink linked to an associated prospect web page.

FIG. 8k shows the quick statistics detail web page 260 that is linked to hyperlink 236. Web page 260 lists prospects derived from other leads such as referrals and mail-ins. The prospects are listed together with their assigned brokers and associated campaigns. Each prospect is presented as a hyperlink linked to an associated prospect web page.

FIG. 81 shows the quick statistics detail web page 262 that is linked to hyperlink 238. Web page 262 lists the prospects for whom insurance policies have been written. Each prospect is listed together with the assigned broker and policy information. The policy information includes the written policy amount, the actual policy amount, the assigned policy symbol, the assigned policy number and the assigned policy model. The policy information can be updated by the user and saved by selecting the save bar 264. Each broker is presented as a hyperlink linked to an associated broker web page that exposes the broker's profile. Each prospect is presented as a hyperlink linked to an associated prospect web page.

FIG. 8m shows the current campaign home web page 266 that is accessed by selecting the campaigns hyperlink 204. The web page 266 identifies each campaign being pursued by the insurer, by broker, target group, target area, start date, mail-in date and required work. The required work identifies which marketing stage the campaign is at. The campaigns in the list are presented as hyperlinks linked to associated campaign web pages similar to that shown in FIG. 8n that expose the campaign profiles. Depending on the marketing stage, the listed marketing stage may be presented as text or as a hyperlink linked to an associated web page.

FIG. 8n shows the campaign web page 268 linked to the eighth campaign listed on the current campaign home web page 266. As can be seen, the campaign web page 268 identifies the campaign target group, the specified geographical region and appointed broker. Web page 268 also identifies the total number of prospects associated with the campaign. The prospects are broken down into the same categories as on the administrator home web page 200. Some of the prospect categories are presented as hyperlinks linked to web pages similar to those shown in FIGS. 8b, 8c, 8g, 8i and 81. The campaign data can be updated and saved by the user by selecting the save changes bar 269. A blank campaign web page 290 (see FIG. 8s) can be opened by selecting the create new campaign bar 270 on web page 266 allowing the user to create and save new campaigns.

FIG. 8o shows a prospects search web page 272 that is opened in response to selection of the view prospects bar 274 on web page 268. The prospects search web page 272 lists all of the prospects in the campaign. Each prospect is presented as a hyperlink linked to an associated prospect web page.

FIG. 8p shows a new prospect input/upload web page 276 that is opened in response to selection of the add prospect bar 278 on web page 268. The web page 276 allows prospects to be browsed and uploaded or allows a blank prospect web page to be opened by selecting the manual entry hyperlink 280. FIG. 8q shows a blank new prospect web page 282 that allows the user to create and save new prospects for the campaign.

FIG. 8r shows an assign telemarketer web page 286 that allows the user to assign a specific telemarketer to a campaign by selecting a check box associated with the desired telemarketer (step 46).

FIG. 8t shows a brokers home web page 292 that is opened in response to selection of the brokers hyperlink 208. The web page 292 identifies each broker by agency number, broker name, telephone number, email address and latest update. The agency numbers are presented as hyperlinks linked to associated brokers web pages. FIG. 8u shows the broker web page 294 associated with the ninth broker listed on web page 292. A new broker web page 296 is shown in FIG. 8v and is opened in response to selection of a create new broker bar 298 on web page 292 allowing the user to create and save a new broker.

FIG. 8w shows a reports home web page 300 that is opened in response to selection of the reports hyperlink 210. The web page 300 includes five hyperlinks linked to reports web pages, namely an all active campaigns summary hyperlink 302, an all active campaigns summary breakdown hyperlink 304, an all active brokers summary hyperlink 306, a year to date report hyperlink 308 and an expiry dates summary hyperlink 310.

Selection of hyperlink 302 opens an all active campaigns summary web page 320 as shown in FIG. 8x. The web page 320 lists each campaign pursued by the insurer, the broker appointed to handle each campaign and statistical information relating to each campaign. The brokers are presented as hyperlinks linked to associated broker web pages. The campaigns are also presented as hyperlinks linked to associated campaign web pages.

Selection of hyperlink 304 opens an all active campaigns summary web page 322 as shown in FIG. 8y. The web page 322 lists all active campaigns pursued by the insurer broken down by appointed broker together with statistical information relating to the campaigns. The brokers are presented as hyperlinks linked to associated broker web pages.

Selection of hyperlink 306 opens an all active brokers summary web page 324 as shown in FIG. 8z. The web page 324 lists each active broker appointed by the insurer and presents statistical information relating to each active broker's performance over all campaigns handled by that broker.

Selection of hyperlink 308 opens a year to date report by producer web page 326 as shown in FIG. 8aa. The web page 326 lists each producer handling campaigns and presents statistical information relating to each producer's performance over all campaigns handled by that producer. The brokers are presented as hyperlinks linked to associated broker web pages. The producers are also presented as hyperlinks linked to associated producer web pages (not shown). Selecting a radio button on the web page 326 allows a similar year to date web page 328 to be opened that is based on prospect as shown in FIG. 8bb.

Selection of hyperlink 310 opens an expiry dates calendar web page 330 as shown in FIG. 8cc. The web page 330 lists each campaign pursued by the insurer, the broker appointed to each campaign and the number of expiry dates acquired from actual prospects for the campaign on a month by month basis.

FIG. 8dd shows a search web page 332 that is opened in response to selection of the update hyperlink 212. The search web page 332 allows the user to perform a search of the database 80 based on prospect name. FIG. 8ee shows a search result web page 334 presenting the results of such a search.

The marketing and sales application also includes query and search features that can be accessed by selecting the query and search hyperlinks 214 and 216 respectively. Selecting the query hyperlink 214 opens a query web page 336 that allows the database 80 to be searched based on a variety of qualifiers as shown in FIG. 8ff. Selecting the search hyperlink 216 opens a prospect search web page 338 that allows the database 80 to be searched based on prospect as shown in FIG. 8gg.

As will be appreciated, the marketing and sales application GUI allows the insurer to review, update and maintain all relevant data associated with all of the campaigns pursued by the insurer. Since the marketing and sales application generates campaign statistical information, the marketing and sales application allows telemarketer and broker performance to be effectively monitored by the insurer.

Telemarketer Web Pages

FIG. 9a shows the telemarketer home web page 400 that is presented to the telemarketer user when the user logs into the marketing and sales application. As can be seen, a pair of hyperlinks are provided across the top of the web page 400, namely a telemarketer home hyperlink 402 and an appointments made hyperlink 404. The home hyperlink 402 is linked to the telemarketer home web page 400. The other hyperlink 404 is linked to another web page as will be described. The hyperlinks 400 and 402 appear across the top of each of the telemarketer web pages to facilitate navigation. In addition to above described hyperlinks, the telemarketer home web page 400 presents a list of the campaigns the insurer has appointed to the telemarketer (step 46). The appointed broker for each campaign as well as the campaign prospect list and status are also listed. The campaign status identifies the status of each campaign as either complete or in progress. The campaign prospect list is presented as a hyperlink either to a statistics web page if the campaign has been completed or a view prospects list web page if the campaign has not been completed.

The campaign web page 406 associated with the first campaign listed on web page 400 is shown in FIG. 9b. The completed campaign web page 406 identifies the total number of prospects for the associated campaign that were called broken down into a variety of categories. These categories include the number of prospects awaiting a first call, the number of prospects awaiting a follow-up call, the number of appointments made, the number of ex-dates received, the number of cold leads and the number of dead leads.

The campaign web page 408 associated with the thirteenth campaign listed on web page 400 is shown in FIG. 9c. Similar to the campaign web page 406, the campaign web page 408 identifies the total number of prospects for the associated campaign to be called broken down into the same variety of categories. In addition, the campaign web page 408 lists each of the prospects either awaiting a first call or awaiting a follow-up call. The prospects are presented as hyperlinks linked to associated prospect web pages.

FIG. 9d shows the prospect web page 410 for the second prospect listed on the campaign web page 408. As can be seen, the prospect web page in addition to information data fields includes three prospect status radio buttons 412 to 416 that are used to set the status of the prospect. Specifically, the prospect status radio buttons include a generate lead radio button 412, a reject prospect radio button 414 and a save & follow up later radio button 416. When the save & follow up later radio button is selected 416, the prospect remains in the awaiting a follow-up call category.

The generate lead radio button 412 is selected when the telemarketer sets up an appointment with the prospect and/or receives an ex-date from the prospect (i.e. the prospect is identified as an actual prospect). When the generate lead radio button 412 is selected, the telemarketer is prompted to enter the appointment time and date and/or ex-date into a dialog box 418 as shown in FIG. 9e. The reject prospect radio button 414 is selected when the telemarketer fails to set up an appointment with the prospect and/or fails to receive an ex-date from the prospect. When the reject prospect radio button 414 is selected, the telemarketer is prompted to enter a rejection reason via a dialog box 420 as shown in FIG. 9f.

FIG. 9g shows an appointment list web page 422 that is opened in response to selection of the appointments made hyperlink 404. As can be seen, the appointment list web page 422 identifies all of the appointments made by the telemarketer by date, prospect name, province, telephone number, campaign and assigned broker.

As will be appreciated, the marketing and sales application GUI allows the telemarketer to manage efficiently each campaign the telemarketer handles. The GUI also permits the telemarketer to input relevant appointment and/or ex-date information into the marketing and sales application allowing actual prospects to be determined by the marketing and sales application in real time. This of course permits faster lead turnaround time.

Broker Web Pages

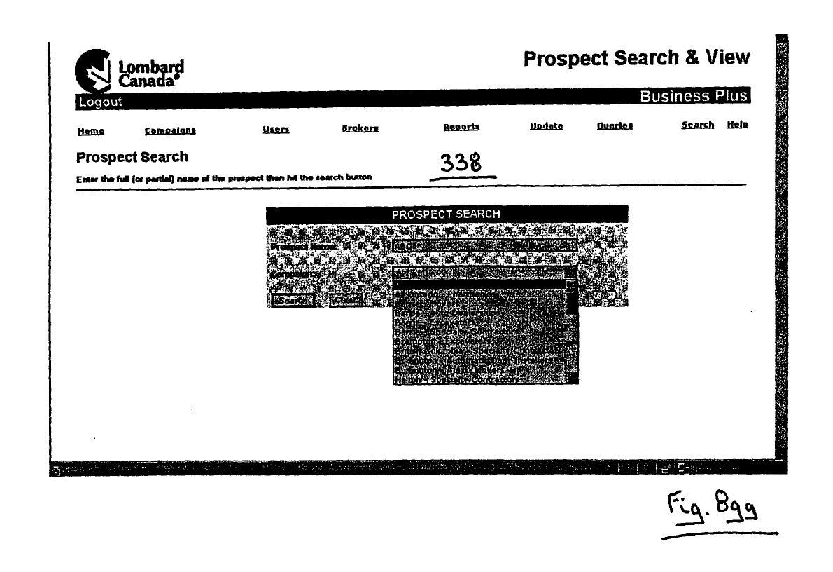

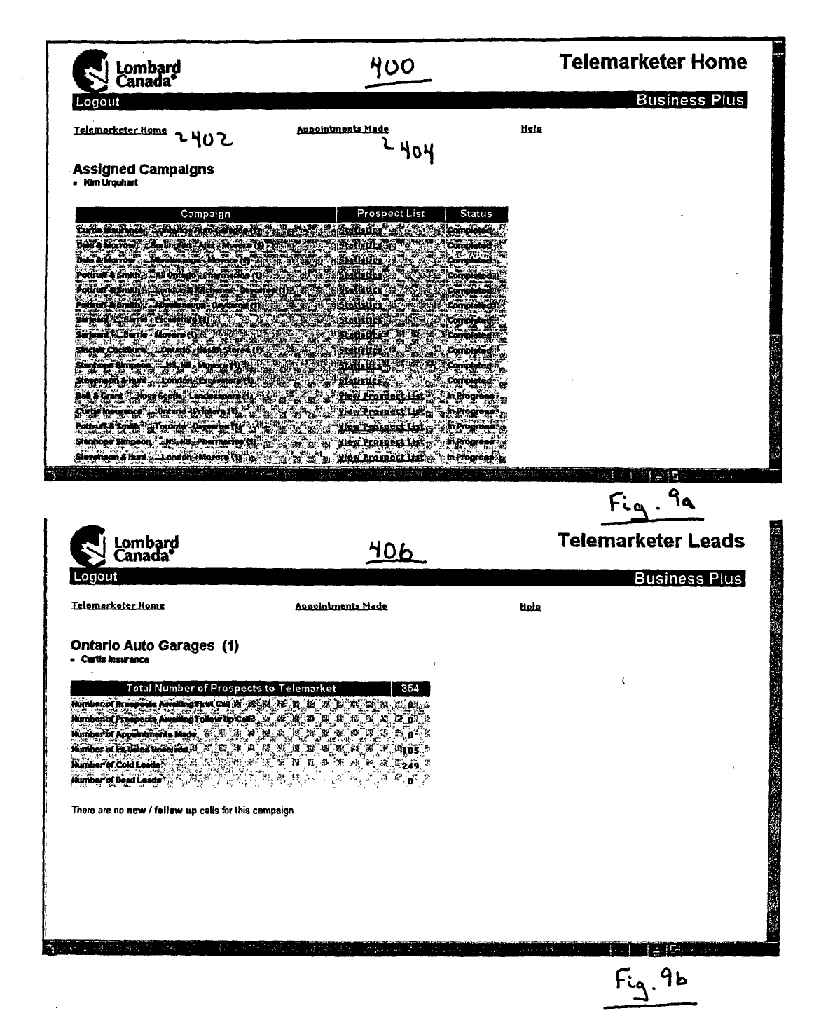

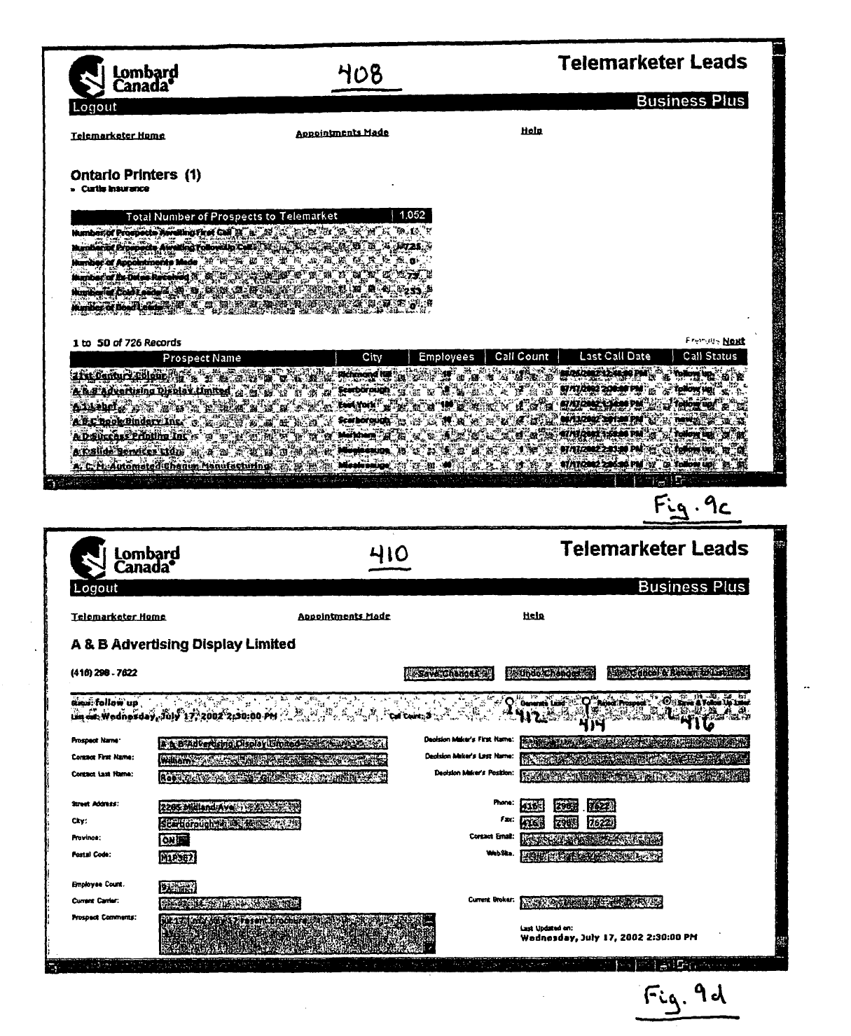

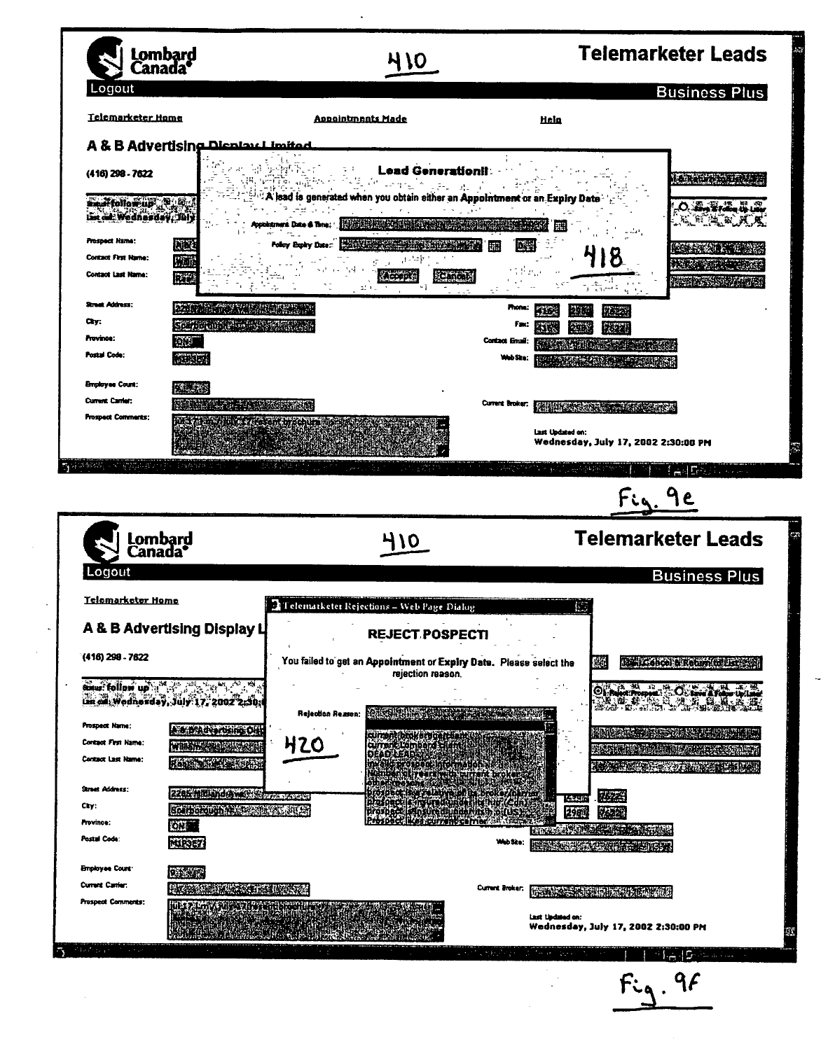

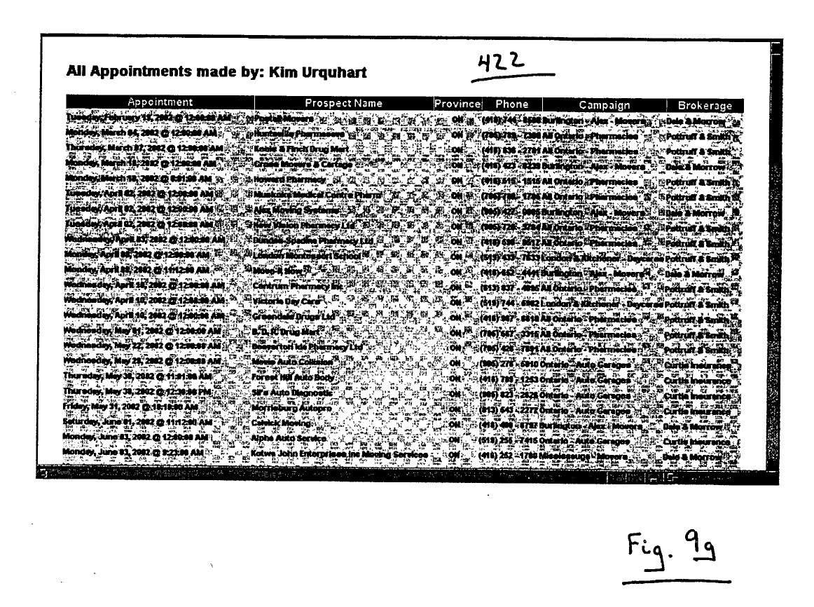

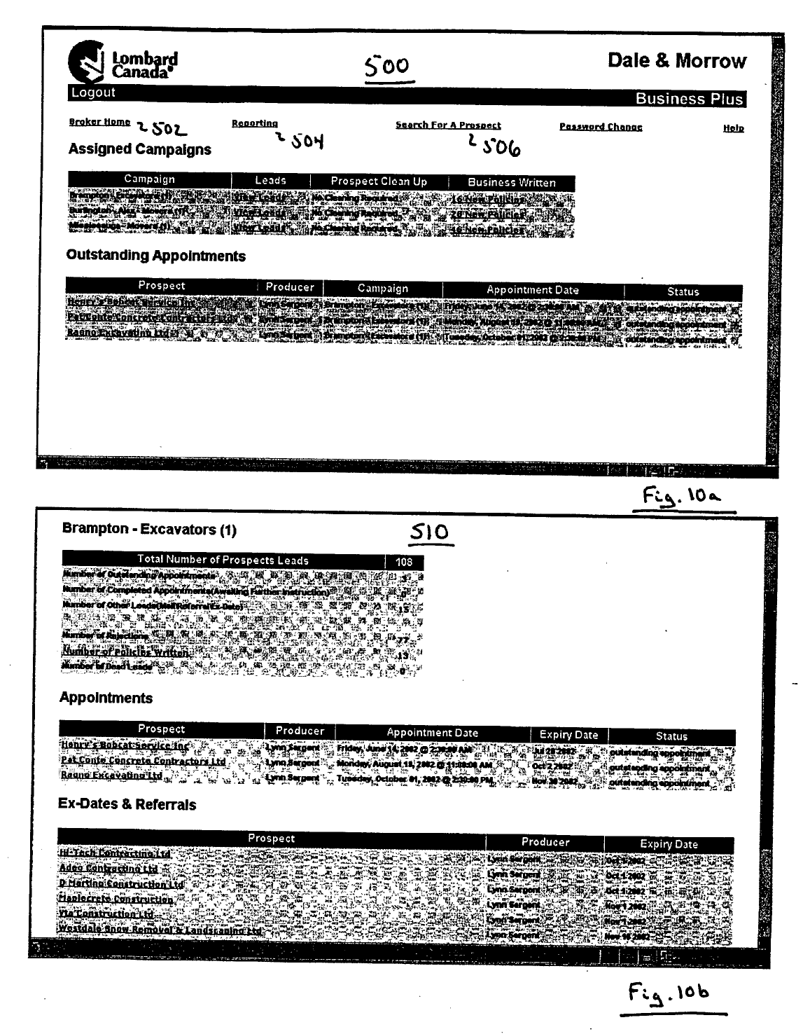

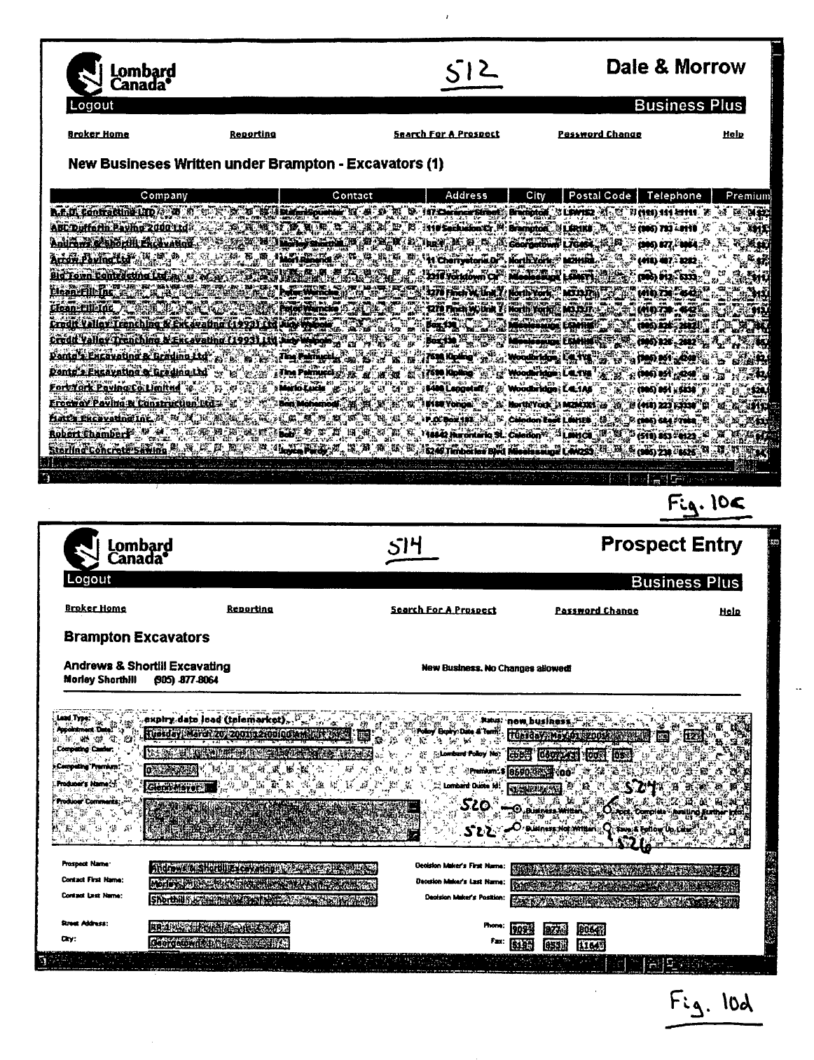

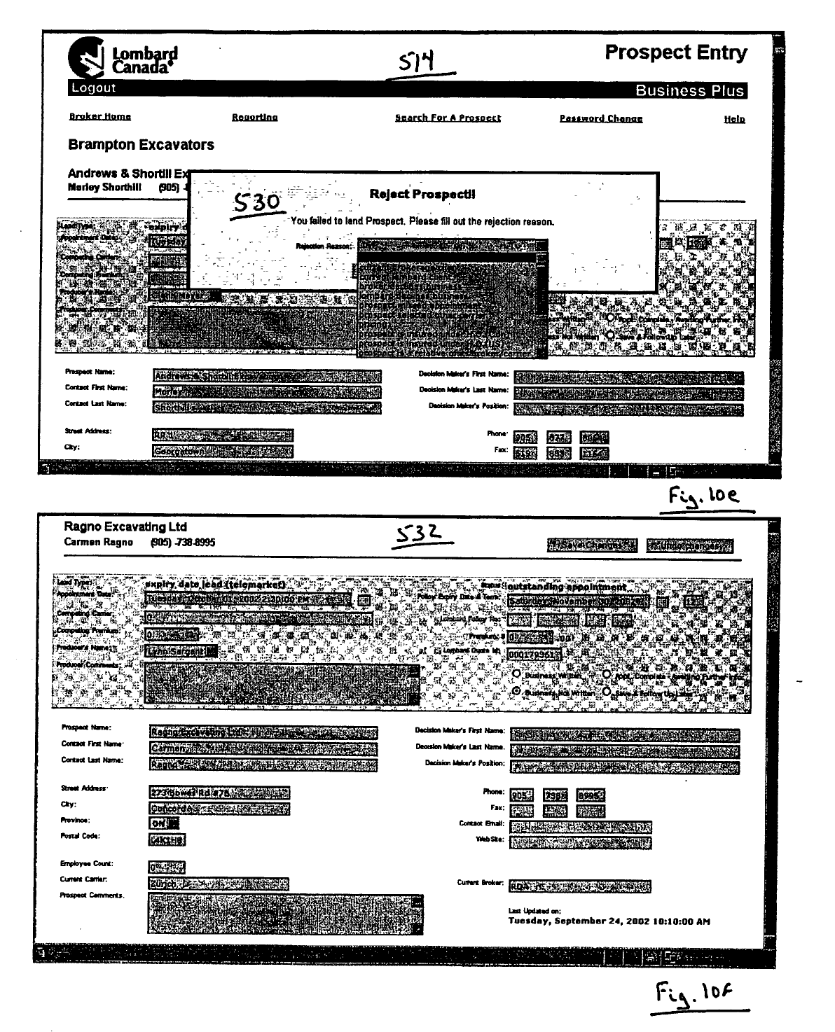

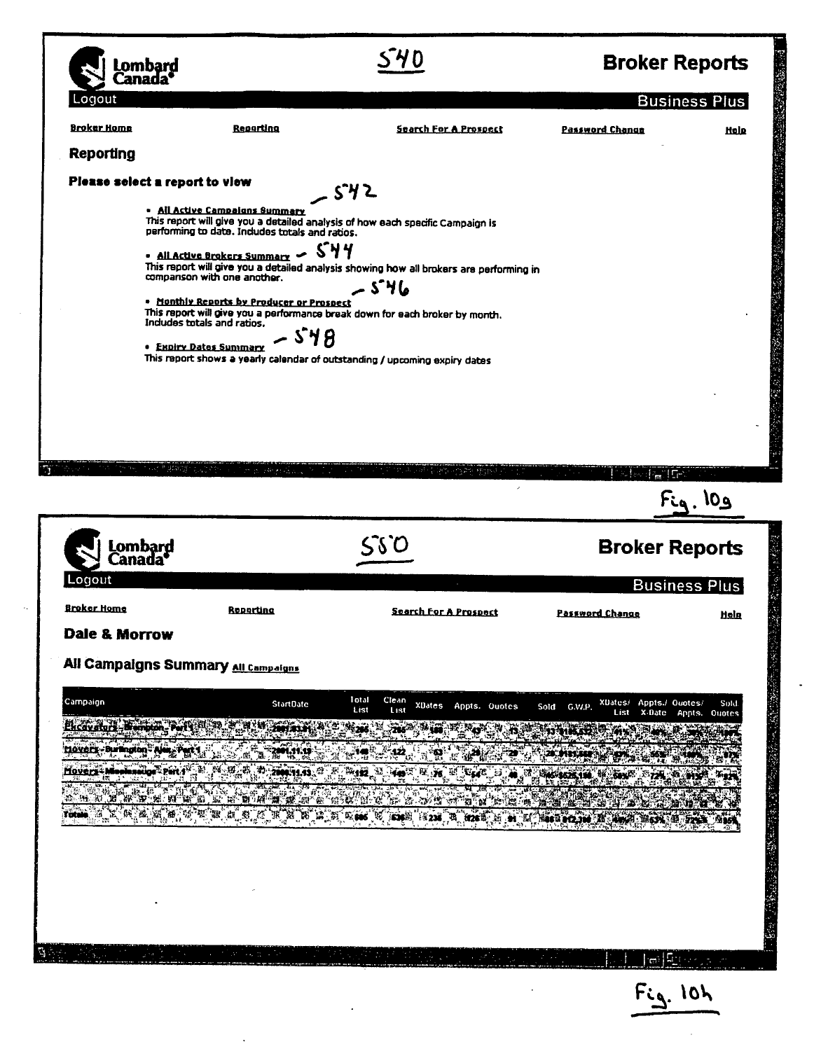

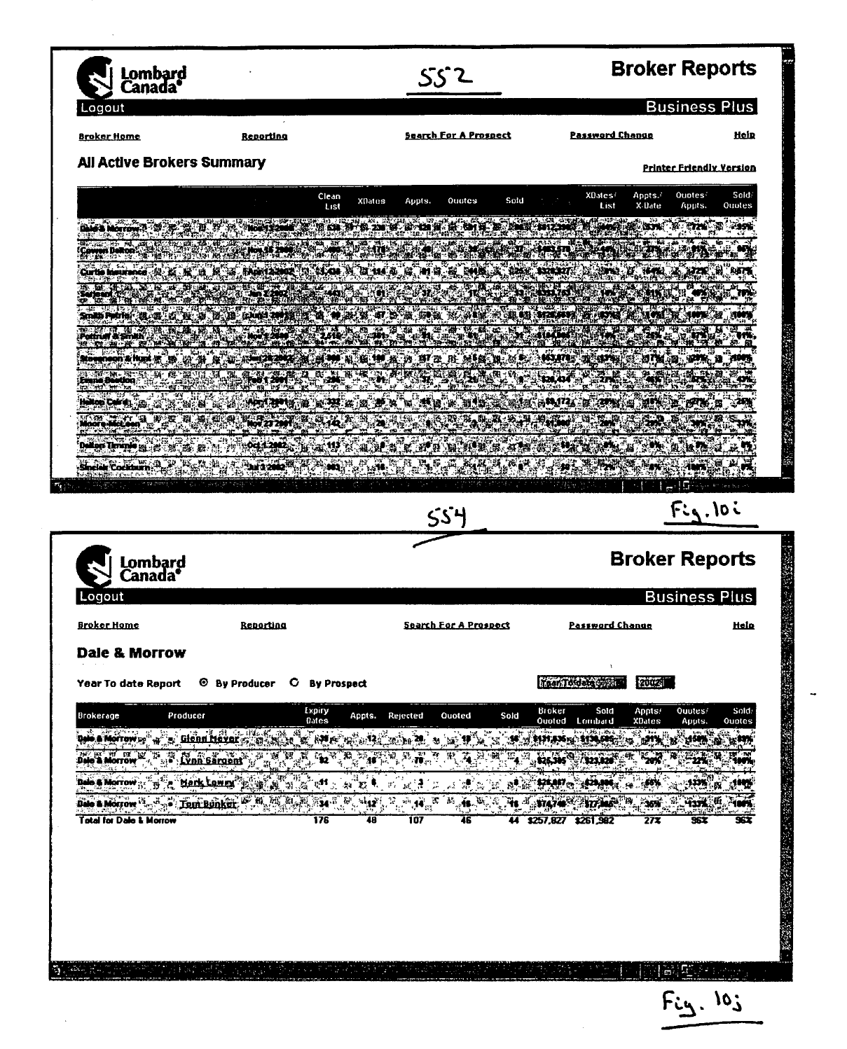

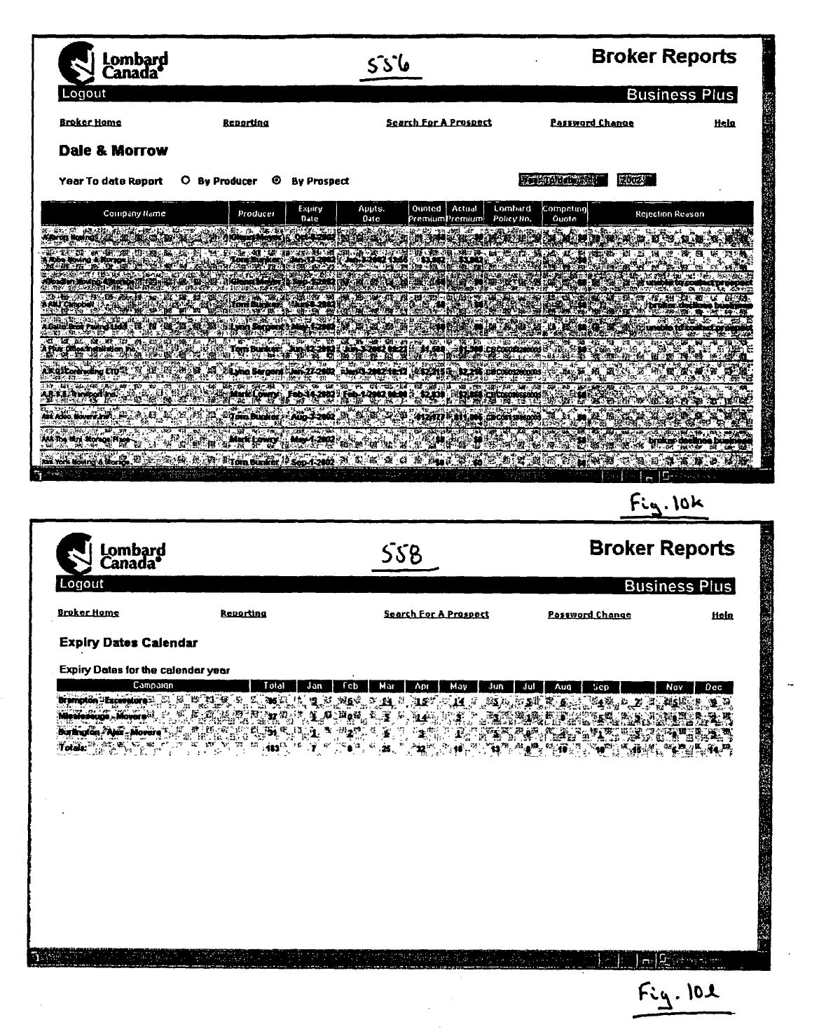

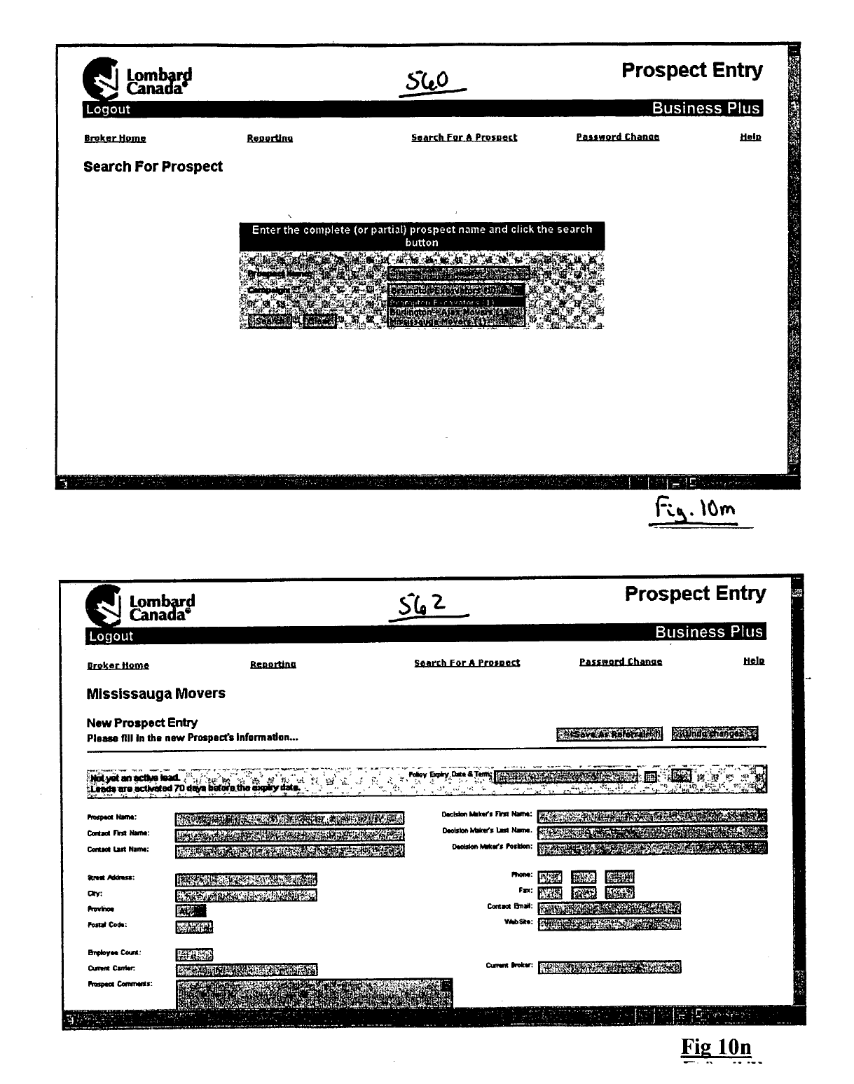

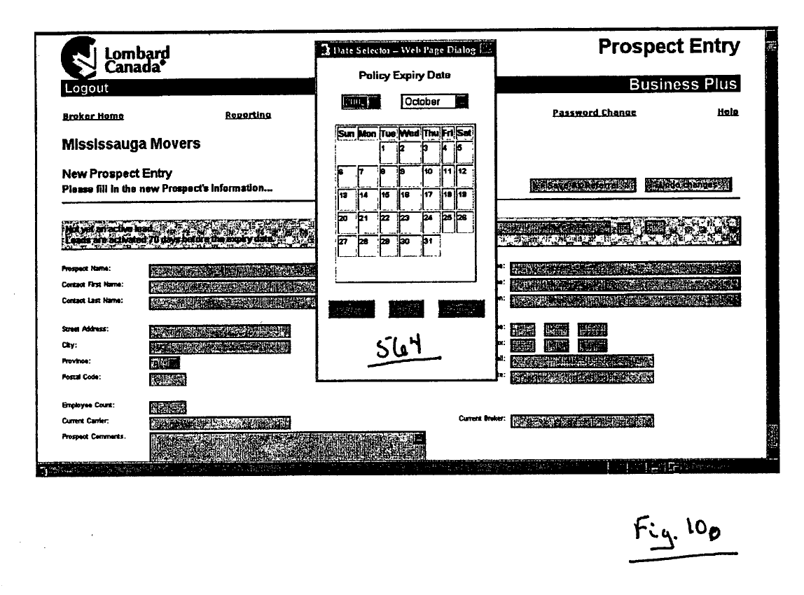

FIG. 10a shows the brokers home web page 500 that is presented to the broker user when the user logs into the marketing and sales application. As can be seen, a series of hyperlinks are provided across the top of the web page 500, namely a broker home hyperlink 502, a reporting hyperlink 504, and a search for prospect hyperlink 506. The broker home hyperlink 502 is linked to the brokers home web page 500. The other hyperlinks 504 and 506 are linked to other web pages as will be described. The hyperlinks 502 to 506 appear across the top of each of the broker web pages to facilitate navigation. In addition to the above described hyperlinks, the brokers home web page 400 lists the campaigns that have been assigned to the broker as well as outstanding appointments. Each campaign in the list is identified by name, leads, prospect clean up and policies written. The leads are presented as hyperlinks linked to associated lead web pages. The policies written are also presented as hyperlinks linked to associated policy web pages. Each outstanding appointment in the list is identified by prospect, producer, campaign, appointment date and status. The prospects are presented as hyperlinks linked to associated prospect web pages.

The lead web page 510 associated with the first campaign in the list presented on web page 500 is shown in FIG. 10b. As can be seen, the lead web page 510 identifies the total number of prospect leads for the associated campaign broken down into a variety of categories. These categories include the number of outstanding appointments, the number of completed appointments that are awaiting further instruction, the number of other leads, the number of rejections, the number of policies written and the number of dead leads. The number of policies written is presented as a hyperlink linked to an associated policies web page. The lead web page 510 also lists the outstanding appointments shown on the broker home web page 500 as well as a list of ex-dates and referrals. The ex-dates and referrals in the list are identified by prospect, producer and ex-date. The prospects are presented as hyperlinks linked to associated prospect web pages.

The policies written web page 512 associated with the first campaign in the list presented on web page 500 is shown in FIG. 10c. The policies written web page 512 lists prospects for whom new policies have been written as well as premium information concerning the written policies. The prospects are presented as hyperlinks linked to associated prospect web pages.

Turning now to FIG. 10d, the prospect web page 514 associated with the third prospect in the policies written list presented on web page 512 is shown. As can be seen, the prospect web page 514 includes identification and policy data fields as well as four selectable radio buttons 520 to 526. The radio buttons include a business written radio button 520, a business not written radio button 522, an appointment complete awaiting further information radio button 524 and a save & follow up later radio button 526. When the save & follow up later radio button 526 is selected, the prospect remains in the outstanding appointments category. When the appointment complete awaiting further information radio button 524 is selected, the prospect is placed in the completed appointments that are awaiting further instruction category.

The business not written radio button 522 is used when the broker fails to land the prospect. When the business not written radio button is selected 522, the broker is prompted to enter a rejection reason via a dialog box 530 as shown in FIG. 10e. The prospect is then placed in the rejections category.

FIG. 10f shows the prospect web page 532 associated with a prospect in the appointment list presented on web page 500. As can be seen, the prospect web page 532 is similar to web page 514 and identifies the date of the outstanding appointment. Since a policy has not been written for this prospect, the policy data fields are incomplete.

FIG. 10g shows the reporting home page 540 that is accessed by selecting the reporting hyperlink 504. As can be seen the reporting home page 540 includes an all active campaigns summary web page hyperlink 542, an all active brokers summary web page hyperlink 544, a monthly reports by producer or prospect hyperlink 546 and an expiry dates summary hyperlink 548.

Selecting hyperlink 542 opens the all active campaigns summary web page 550 as shown in FIG. 10h. The web page 550 lists all of the campaigns handled by the broker together with statistical information for each campaign. The statistical information includes the total number of prospects in the campaign, the number of prospects in the campaign after cleaning, the number of ex-dates acquired, the number of appointments made, the number of quotes provided to prospects, the number of policies written, the value of the policies, the number of ex-dates acquired vs. the number of prospects after cleaning, the number of appointments vs. the number of acquired ex-dates, the number of quotes vs. the number of appointments and the number of written policies vs. the number of quotes. The campaigns are presented as hyperlinks linked to associated campaign web pages.

Selecting hyperlink 544 opens the all active brokers summary web page 552 as shown in FIG. 10i. The web page 552 lists each of the brokers used by the insurer and presents statistical information for the brokers across all of the campaigns handled by the brokers.

Selecting hyperlink 546 opens the monthly reports by producer web page 554 as shown in FIG. 10j. The web page 554 lists each producer associated with the broker. Statistical information associated with each producer is also listed. The statistical information includes the number of ex-dates acquired by the producer, the number of appointments set up by the producer, the number of rejections, the number quotes made by the producer, the number of policies sold by the producer, the amount quoted by the broker for that producer, the amount of business sold to the insurer for the producer as well as the appointment vs. ex-date, quote vs. appointments and sold vs. quote ratios. The monthly report by prospect web page 556 is opened by selecting the radio button 558 on web page 554 as shown in FIG. 10k. The web page 556 lists each prospect, the producer associated with the prospect and the ex-date associated with the prospect. The monthly report by prospect web page 556 also lists for each prospect, the appointment date, quoted premium, actual premium, underwriter policy number, competing quote and rejection reason.

Selecting hyperlink 548 opens the expiry dates calendar web page 558 as shown in FIG. 101. The web page 558 lists the number of ex-dates on a month by month basis for each of the campaigns handled by the broker.

FIG. 10m shows the search home web page 560 that is accessed by selecting the hyperlink 506. The search home web page 560 allows searches to be performed based on prospect name or campaign.

FIG. 10n shows the a new prospect entry web page 562 that is completed by the broker when a new prospect for a campaign is acquired through a referral or other lead. In addition to contact information data fields, the new prospect entry web page 562 includes an ex-date policy data field. The ex-date information is entered into this data field using the date selector dialog box 564 shown in FIG. 10o. When a new prospect is created by a broker, the new prospect becomes active 70 days in advance of the ex-date.

As will be appreciated, the marketing and sales application GUI allows the broker to manage appointments for the various handled campaigns and monitor performance overall and by producer. The GUI also allows the broker to compare their performance with other brokers appointed by the insurer.

The present targeted marketing method and supporting marketing and sales application allow targeted groups for a marketed item to be effectively managed and monitored. This of course can translate directly into increased sales. Non-profitable targeted groups can be quickly determined thereby avoiding lengthy wasted marketing efforts.

Although the targeted marketing method and supporting marketing and sales application have been described with particular reference to the marketing and sale of insurance, those of skill in the art will appreciate that the present targeted marketing method and supporting marketing and sales application may be used to market and sell other items.

Also, although a preferred embodiment of the present invention has been described, those of skill in the art will appreciate that variations and modifications may be made without departing from the spirit and scope thereof as defined by the appended claims.

What is claimed is:

1. A distributed computer network comprising:
an item provider computer system maintaining at least one campaign in a database, said at least one campaign identifying a list of prospects operating businesses in a common industry that are within a specified geographical area, said item provider computer system running a marketing and sales application, said marketing and sales application allowing an item provider user to electronically appoint a telemarketer for said at least one campaign and an agent for said at least one campaign;
at least one telemarketer client computer system communicating with said item provider computer system over a secure Internet connection to enable said telemarketer to interact with said marketing and sales application, said telemarketer being provided with on-line access to the list of prospects in said database when said telemarketer is electronically appointed; and
at least one agent client computer system communicating with said item provider computer system over a secure Internet connection to enable said agent to interact with said marketing and sales application, said agent being provided with on-line access to a list of prospect leads in said database when said agent is electronically appointed.

2. A distributed computer network according to claim 1 wherein said item provider computer system includes at least one web server and at least one database server, said at least one web server communicating with said at least one telemarketer client computer system and said at least one agent computer system, said at least one database server accessing said database in response to said at least one web server and providing data to said web server for display by one or more of said at least one telemarketer client computer system and said at least one agent computer system.

3. A distributed computer network according to claim 2 wherein said database maintains a plurality of different campaigns and wherein said item provider computer system communicates with a plurality of telemarketer and agent client computer systems.

4. A distributed computer network according to claim 3 wherein said marketing and sales application maintains statistics relating to the performance of one or more of said telemarketer and agent.

5. A distributed computer network according to claim 4 wherein said marketing and sales application automatically generates mailers for dispatch to the prospects in said list in response to input received from said telemarketer client computer systems.

6. A distributed computer network according to claim 5 wherein said marketing and sales application automatically generates mailers for dispatch to said prospect leads in response to data received from said agent client computer systems.

7. An Internet-based marketing and sales application to facilitate targeted marketing of an item supplied by an item provider, said marketing and sales application comprising:
means for maintaining at least one campaign in a database, said campaign identifying a list of prospects operating businesses in a common industry that are within a specified geographical area;
means for appointing a telemarketer to said campaign electronically thereby to provide said telemarketer with on-line access to the list of prospects in said database, said telemarketer contacting the prospects in said list to enlist prospects potentially interested in purchasing said item (“actual prospects”); and
means for appointing an agent to said campaign electronically thereby to provide said agent with on-line access to a list of actual prospects, said appointed agent contacting the actual prospects in the list in an attempt to sell said item to said actual prospects.

8. A method for targeted marketing of an item comprising the steps of:
establishing a campaign for said item, said campaign identifying a list of prospects within a specified geographical region;
appointing an agent to said campaign;
appointing a telemarketer to said campaign, said telemarketer contacting the prospects in said list to determine prospects potentially interested in said item (“actual prospects”); and
providing said appointed agent with a list of the actual prospects, said appointed agent contacting the actual prospects in an attempt to sell said item to said actual prospects.

9. The method of claim 8 wherein during said establishing the list of prospects is cleaned to remove prospects who are already either clients of the item provider and/or clients of the appointed agent.

10. The method of claim 9 wherein the prospects in said list operate businesses in a particular industry sector.

11. The method of claim 10 wherein prior to appointing said telemarketer, the list of prospects and appointed agent are verified as being profitable.

12. The method of claim 10 wherein during said establishing said list of prospects is developed using a plurality of different resources.

13. The method of claim 12 wherein said list of prospects is initially developed using resources including Dunn & Bradstreet, association lists, brokers lists and/or other list sources that identify potential prospects within said specified geographical region.

14. The method of claim 13 wherein said list of prospects is further expanded using Internet searches, library resources and/or other research.

15. The method of claim 12 further comprising the step of forwarding mailers to the prospects in said list prior to the telemarketer contacting said prospects.

16. The method of claim 15 further comprising the step of forwarding additional mailers to the actual prospects prior to the appointed agent contacting said actual prospects.

17. The method of claim 16 wherein said additional mailers provide an indication to the actual prospects as to when they can expect to be contacted by said appointed agent.

18. The method of claim 17 wherein said telemarketer asks each actual prospect a series of questions and gathers data based on the answers to said questions, the gathered data being used to determine when the appointed agent contacts each actual prospect.

19. The method of claim 18 wherein said item is insurance and wherein the gathered data used to determine when the appointed agent contacts each actual prospect is the expiry date (“ex-date”) of each actual prospect's existing insurance policy.

20. The method of claim 19 wherein the appointed agent contacts each actual prospect a fixed number of days prior to said ex-date.

21. A method for targeted marketing of insurance offered by an insurer comprising the steps of:
establishing a campaign for said insurance, said campaign identifying a list of prospects within a specified geographical region that operate businesses in a particular industry sector;
appointing a broker to said campaign;
appointing a telemarketer to said campaign, said telemarketer contacting the prospects in said list to enlist prospects potentially interested in said insurance (“actual prospects”); and
providing said appointed broker with a list of the actual prospects, said appointed broker contacting the actual prospects in an attempt to sell said insurance to said actual prospects.

22. The method of claim 21 wherein during said establishing the list of prospects is cleaned to remove prospects who are already either clients of the insurer and/or clients of the appointed broker.

23. The method of claim 22 wherein prior to appointing said telemarketer, the list of prospects and appointed broker are verified as being profitable.

24. The method of claim 22 wherein during said establishing said list of prospects is developed using a plurality of different resources.

25. The method of claim 24 wherein said list of prospects is initially developed using resources including Dunn & Bradstreet, association lists, brokers lists and/or other list sources that identify potential prospects within said specified geographical region.

26. The method of claim 25 wherein said list of prospects is further expanded using Internet searches, library resources and/or other research.

27. The method of claim 24 further comprising the step of forwarding mailers to the prospects in said list prior to the telemarketer contacting said prospects.

28. The method of claim 27 further comprising the step of forwarding additional mailers to the actual prospects prior to the appointed broker contacting said actual prospects.

29. The method of claim 28 wherein said additional mailer provides an indication to the actual prospects as to when they can expected to be contacted by said appointed broker.

30. The method of claim 29 wherein said telemarketer asks each actual prospect a series of questions and gathers data based on the answers to said questions, the gathered data being used to determine when the appointed broker contacts each actual prospect.

31. The method of claim 30 wherein the gathered data used to determine when the appointed broker contacts each actual prospect is the expiry data (“ex-date”) of each actual prospect's existing insurance policy.

32. The method of claim 31 wherein the appointed broker contacts each actual prospect a fixed number of days prior to said ex-date.

33. The method of claim 32 further comprising the step of selling insurance to actual prospects interested in purchasing insurance.

34. The method of claim 33 further comprising the step of maintaining statistics relating to the appointed broker's performance in selling insurance to said actual prospects.

35. The method of claim 34 further comprising the step of maintaining statistics relating to the telemarketer's performance in enlisting actual prospects.

36. An Internet-based method for targeted marketing of an item supplied by an item provider, said method comprising the steps of:
maintaining at least one campaign in a database, said campaign identifying a list of prospects operating businesses in a common industry that are within a specified geographical area;
appointing a telemarketer to said campaign electronically thereby to provide said telemarketer with on-line access to the list of prospects in said database, said telemarketer contacting the prospects in said list to enlist prospects potentially interested in purchasing said item (“actual prospects”); and
appointing an agent to said campaign electronically thereby to provide said agent with on-line access to a list of actual prospects, said appointed agent contacting the actual prospects in the list in an attempt to sell said item to said actual prospects.

37. The method of claim 36 wherein said telemarketer electronically identifies said actual prospects and wherein said appointed agent electronically identifies actual prospects wishing to purchase said item.

38. The method of claim 37 further comprising the step of instructing the appointed agent electronically to sell the item to the actual prospects.

39. The method of claim 38 further comprising the step of maintaining statistics relating to the appointed agent's performance in selling said item to said actual prospects in said database.

40. The method of claim 39 further comprising the step of providing said appointed agent on-line access to said statistics.

41. The method of claim 33 further comprising the step of maintaining statistics relating to the telemarketer's performance in enlisting actual prospects.

42. The method of claim 38 wherein said item is insurance.

43. The method of claim 42 further comprising the step of automatically generating mailers to the prospects in said list and dispatching said mailers to said prospects prior to the telemarketer contacting said prospects.

44. The method of claim 43 further comprising the step of automatically generating additional mailers to the actual prospects identified by said telemarketer and dispatching said mailers prior to the appointed agent contacting said actual prospects.

45. The method of claim 44 wherein said additional mailers provide an indication to the actual prospects as to when they can expect to be contacted by said appointed agent.

46. The method of claim 45 wherein said telemarketer asks each actual prospect a series of questions and gathers data based on the answers to said questions, the gathered data being used to determine when the appointed agent contacts each actual prospect.

47. The method of claim 46 wherein the gathered data used to determine when the appointed agent contacts each actual prospect is the expiry date (“ex-date”) of each actual prospects existing insurance policy.

48. The method of claim 47 wherein the appointed agent contacts each actual prospect a fixed number of days prior to said ex-date.

49. The method of claim 38 wherein said database maintains a plurality of campaigns each associated with a different specified geographical area.

50. The method of claim 49 wherein during creation of each said campaign, a list of prospects operating businesses in said common industry within said specified geographical area is initially developed and wherein said list is cloned to remove prospects who are already clients of the item provider and/or appointed agent.

51. The method of claim 50 wherein the list of prospects of each campaign is initially developed using a plurality of different resources.

52. The method of claim 51 wherein the list of prospects for each campaign is initially developed using a plurality of list sources.

53. The method of claim 52 wherein the list of prospects for each campaign is expanded using Internet searches, library resources and/or other research.

54. The method of claim 53 wherein said item is insurance.

55. The method of claim 54 further comprising the step of automatically generating mailers to the prospects in said list and dispatching said mailers to said prospects prior to the telemarketer contacting said prospects.

56. The method of claim 55 further comprising the step of automatically generating additional mailers to the actual prospects identified by said telemarketer and dispatching said mailers prior to the appointed agent contacting said actual prospects.

57. The method of claim 56 wherein said additional mailers provide an indication to the actual prospects as to when they can expect to be contacted by said appointed agent.

58. The method of claim 57 wherein said telemarketer asks each actual prospect a series of questions and gathers data based on the answers to said questions, the gathered data being used to determine when the appointed agent contacts each actual prospect.

59. The method of claim 58 wherein the gathered data used to determine when the appointed agent contacts each actual prospect is the expiry date (“ex-date”) of each actual prospects existing insurance policy.

60. The method of claim 59 wherein the appointed agent contacts each actual prospect a fixed number of days prior to said ex-date.

61. A method for targeted marketing of an item supplied by an item provider comprising the steps of:
performing, by the item provider, initial prospecting to identify a list of prospects for the item; and
providing targeted leads to an agent associated with the item provider to enable the agent to contact selected prospects in the list in an attempt to sell said item.

62. The method of claim 61 further comprising the step of instructing a telemarketer to contact the prospects in the list to determine the selected prospects.

63. The method of claim 62 wherein said item is insurance.
